(19) United States
(12) Patent Application Publication
(10) Pub. No.: US 2023/0350961 A1
(43) Pub. Date: Nov. 2, 2023

(54) SYSTEMS AND METHODS FOR PROVIDING AN ELECTRONIC SEARCH SYSTEM

(71) Applicant: Joshua Rubenstein, Jackson, NJ (US)

(72) Inventor: Joshua Rubenstein, Jackson, NJ (US)

(21) Appl. No.: 17/730,836

(22) Filed: Apr. 27, 2022

(51) Int. Cl. G06F 16/9538; G06F 16/9532; G06F 16/9032; G06F 3/0482

(52) U.S. Cl. CPC G06F 16/9538; G06F 16/9532; G06F 16/90324; G06F 3/0482

(57) ABSTRACT

Embodiments of the present invention provide for systems and methods for a computer implemented method. The method comprises providing an input device having at least one processor and a graphical user interface (GUI) displaying a search input area. The method further includes: receiving a search query from a user of the input device; determining, with the at least one processor, at least one search element to display on the GUI; requesting, from a server, two or more lists of search suggestions; displaying, on the GUI, the two or more lists of search suggestions to the user as the user enters the search query; and detecting, with the at least one processor, a user interaction with one of the two or more lists of search suggestions.

### FIELD OF THE INVENTION

The present disclosure relates generally to systems and methods for providing an electronic search system. More specifically, one or more embodiments of the present invention relate to systems and methods of providing a user interface for use in connection with searching the web.

### BACKGROUND OF THE INVENTION

Computing devices (e.g., computers, tablets, and smartphones) have created numerous ways for people to search the internet. For example, a variety of electronic search systems provide various methods to input search queries and receive search suggestions and/or search results. For instance, a computing device can allow a user to type search queries to find a desired internet domain, to navigate to a particular web page, or to research information. In general, the search bar has become the most ubiquitous interface, and the primary way in which people access the web.

Due to the wide variety of ways in which people search the web, users are often faced with typing a large number of very different queries on a daily basis. To increase the efficiency of finding information online, many conventional electronic search systems present the user with suggestions (e.g., query recommendations) within an electronic search system as a shortcut to help users search faster. A helpful suggestion can act as a shortcut because less user input (e.g., less typing) may be required in order to find information using the electronic search system compared to typing the same query manually. Including suggestions in an electronic search system also helps users discover better queries which the user may not have thought of without the recommendations.

Although traditional search suggestions are generally helpful, several disadvantages exist with respect to the conventional search suggestions. For example, users often desire to navigate to one particular known website domain (e.g., Facebook.com), or a particular web page on a particular domain (e.g., Homedepot.com/lumber) and don't have the need to see a page full of link results. Most conventional search suggestion systems, however, are designed to suggest better queries, which lead a user to the SERP (search engine results page). Thus, the user is forced to take extra time to enter several words, then to browse through a list of links on a SERP which requires the user to let go of the keyboard and use another input device such as a mouse, is often riddled with ads, and takes a fair amount of concentration to pick the correct link.

To address the lack of flexibility that a single list of search query recommendations can offer, some conventional electronic search systems may include website domain recommendations, or suggested web pages from a user's history, in an attempt to provide the user with a web page that closely matches the user's search query. These search suggestion systems, however, can cause the user difficulty if the user simply wants to visit that domain's homepage. For example, if a user has visited a particular article on medium.com, then would like to visit the home page of medium.com later in time, the first suggestion would often take the user to that particular article again instead of to the homepage. In short, users tend to be overwhelmed when search suggestions are on a single list since they lack organization, visual hierarchy, or depth. Unfortunately, in current search engines, the vast majority of the time, most of the suggestions, beyond the initial query recommendations, distract and hinder more than they help. This is particularly unfortunate since the search bar is the single most used software interface in the world. Google® alone has 5.6 Billion queries daily, and that's only queries which end up on the SERP.

In addition, due to the large number of web pages that most users have saved in their browsing history, the suggestions wind up being distracting. For example, a user typing the letter “a” into a search bar might get recommendations from a wide variety of URLs which happen to match that letter (e.g., Zoho Accounts since the letter “a” matches). The user receiving this list of suggestions, however, is distracted by both the irrelevant suggestion and the long string of characters which make up the URL and are included in the suggestion text. To remedy this, some search suggestions have begun adding flashy content with images along with the search suggestions, such as pictures of notable people or places in the hopes that this might bury the most irrelevant suggestions, but these flashy suggestions often wind up being distracting as well. The confusion created due to the large number of available suggestions being recommended in a single list causes the electronic search system to be less efficient and more frustrating to the users.

One or more embodiments described below provide benefits and/or solve one or more of the foregoing or other problems in the art with methods and systems for providing users with an improved electronic search suggestion system. For example, the principles described herein provide a graphical user interface (GUI) which includes two lists of suggestions and allows a user to easily and quickly select an electronic search element from either list. Once the user highlights, or selects an electronic search element from one list, the graphical user interface may further alter the state of the second list of suggestions, and allow the user to quickly and easily highlight, or select an element from the second list of suggestions. In one embodiment, a horizontal list of suggestions which may include large visual icons is displayed above the search bar, while a vertical list of suggestions which may include text, is displayed under the search bar.

Due to the ability to select an electronic search element from either list, a user can easily focus on the more relevant list of suggestions initially, while ignoring the other. For example, in one list, the graphical user interface may provide the user with a list of domains, and in a second list, the graphical user interface may provide the user with a vertical list of web pages within that domain. In particular, one or more embodiments allow a user to type a query (e.g., “us”) and then highlight, or select an item from the first list of suggestions, such as a domain (e.g., https://www.uspto.gov). Using the methods and systems described herein, the user can then select an item from the second list, which may include particular web pages on that domain (e.g., https://www.uspto.gov/ip-policy). If the user highlights a different domain from the first list (e.g., https://www.usa.gov), the vertical list of suggestions might be updated to include suggestions for web pages within that domain (e.g. https://www.usa.gov/passport). Thus, the methods and systems described herein allow a user who is aiming to visit a specific web page to select one or more electronic search elements to find or navigate to the exact location on the internet that the user wishes to visit without the need for a SERP.

In addition, one or more embodiments provide methods and systems that allow a user to view and select search results efficiently and intuitively without the need to navigate to a conventional search results page. Traditional search results pages take a good deal of cognitive effort to sort through. In particular, the principles described herein provide a graphical user interface that allows a user to view search results as a list of search suggestions, which may be displayed as the user types queries, along with a second list of query recommendations. This list of results might be displayed as a horizontal list of icons and be accessible with minimal user interaction with the graphical user interface. Thus, compared to conventional methods and systems, one or more embodiments described herein provide a more efficient and intuitive way for a user to search the web.

In addition, one or more embodiments provide methods and systems that allow a user to view web pages which are relevant to a search query without the need for the user to navigate first to a separate SERP. In particular, as the user types a query, the search system may recommend a list of search suggestions which include icons representing search results (i.e., web pages which are relevant to the query). When a user highlights one of these icons, the system may display the webpage which the icon represents on the display area of a user's browser while still displaying the list of search suggestions. Since the user is still utilizing the search engine while viewing the web page of the result, the user may then leave feedback on that result. The feedback provided by users may then be utilized to re-rank and thereby improve the quality of the search results for other users.

Additional features and advantages will be set forth in the description which follows, and in part will be obvious from the description, or may be learned by the practice of such exemplary embodiments. The features and advantages of such embodiments may be realized and obtained by means of the instruments and combinations particularly pointed out in the appended claims. These and other features will become more fully apparent from the following description and appended claims or may be learned by the practice of such exemplary embodiments as set forth hereinafter.

### SUMMARY OF THE INVENTION

The techniques of this disclosure generally relate to systems and methods of providing a user interface for use in connection with searching the web.

One or more embodiments of the present invention include an electronic search system that allows a user to type a query and to select or highlight an electronic search element from a list of search suggestions. A list of search suggestions can be displayed on a graphical display in response to a search query, critically, before the system detects a user input signifying the desire to end the query input and go to a SERP (search engine results page). Search suggestions can include one or more search elements which are relevant to the query. For instance, an electronic search element may include a query recommendation, search result, recommended domain, recommended webpage, a symbol, icon, plain text, ad, animation, a button such as a purchase button, a notification, a choice of a search engine, and/or other features that can be highlighted or selected via an electronic search system.

In one or more embodiments, a computer-implemented method comprises receiving, in response to a user input typing some characters of a search query, at the client computer system from a server, a number of search elements related to the particular search query, ranked in the order of relevance. The client side device may then display these search elements within a list of search suggestions, even before a user signifies intent to end the query input.

In one or more embodiments, a list of search suggestions which includes one or more search elements may be displayed above the search bar in a horizontal row, while a user types a query. In one particular embodiment, each search element is displayed as an icon, representing a search result. For example, if a user does a query, and there is a web page which is ranked highly for that query from kickstarter.com, the user interface can display that result displayed as an icon with the Kickstarter logo. In one embodiment, a user may then utilize an input modality to indicate interest in one of these search elements. In one example, this may be the right arrow key. Due to the ability to view search results before pressing the enter key, the user may at times decide to avoid pressing visiting SERP altogether and rely on the list of search elements which have already been displayed as the user typed the query. If the user opts to see the SERP page, the user may simply press the enter key to signify intent to end the query and view the SERP.

In one or more embodiments, a computer-implemented method comprises receiving—in response to a user input indicating interest in, by means of an input device, a search element representing a particular search result—at the client computer system from a server, a screenshot of that search result's web page which has been rendered on a server. Due to the ability to view screenshots of search results, and to switch between the results rapidly by highlighting a search element using an input detector, users may now avoid the common practice of opening a dozen tabs for each search query. Additionally, users can avoid visiting websites which are of low quality, since they now have the ability to see what a website looks like before visiting it. In one embodiment, the search system may render the web page on a server in the cloud, and send a screenshot, or an image of the web page to the client side device. This can save the user on data costs and would help users avoid browser memory overloads where the browser freezes or slows down. In one embodiment, a computer-implemented method is then collaborated to receive a user input signifying that the user would like to upvote or downvote the search element which is representing the web page which is being rendered on the client side device.

In one or more alternative embodiments, a computer-implemented method comprises receiving, at the client computer system from a server, two lists of search suggestions, each comprising one or more search elements, responsive to a search query. These two sets of search suggestions may either be related to each other, or unrelated. In one list of suggestions, the search elements may be displayed in a horizontal row, and in a second list of suggestions, the search elements may be displayed in a vertical row.

In particular, one or more embodiments of the electronic search system allow a user to select or highlight an electronic search element from a list of suggestions, and receive updates to the search interface based on the highlighting or selection of the electronic search element.

Due to the ability to select an electronic search element from one of two lists of suggestions, a user may utilize the electronic search system to quickly and accurately find the precise desired outcome with minimal cognitive load. In particular, the electronic search system allows a user to highlight an electronic search element to indicate interest in a particular web domain, web page, or action, represented by the electronic search element.

In addition, the electronic search system can provide methods and systems that allow a user to select or highlight one or more electronic search elements efficiently and intuitively. In particular, compared to the conventional methods of having a user read through a single list of text-based search suggestions which only loosely match a user's query, the electronic search system allows a user to quickly select a search query suggestion or a destination web domain or web page with ease. Therefore, compared to conventional methods and systems, one or more embodiments of the electronic search system can provide a more efficient and intuitive way for a user to search the web.

In particular, the efficiency at which a user can use the electronic search system to search the web can be based in part on a graphical user interface provided by the electronic search system. For example, the user can interact with the graphical user interface to cause the electronic search system to browse, select, or highlight, one or more search elements. In one or more embodiments, the electronic search system allows a user to indicate interest in an electronic search element by way of typing queries using a keyboard, and then highlighting search elements using the arrow keys or the tab key, or via interacting with a portion of the graphical user interface. For example, the user can interact with a selectable item associated with the electronic search element (e.g., taps a key on the keyboard).

In one or more embodiments, a processor may be configured to receive a user input in selecting, or highlighting, a search element from one of these lists of search suggestions, and in response, to provide updates to the second list of search suggestions. In one or more embodiments, the electronic search system allows a user to then select an electronic search element from the second, updated, list of suggestions.

In one or more embodiments, the invention may provide a user interface for a search bar, the interface including a search box for entering a search query, a list of domain suggestions displayed as icons in a horizontal row above the search box, and a list of suggestions displayed as plain text below the search bar. For example, the user may type a query, then tap the right arrow key to highlight a search element, such as an icon representing a particular domain, from the list of suggestions running along the x axis, and then, in response to having received a second list of suggestions, use the down arrow key to highlight a search element from a second list of suggestions running along the y axis. When the user has found and highlighted the desired search element from the second list of search suggestions, such as a particular webpage, the user may tap the enter key to select that search element. Thus, the methods and systems described herein allow a user to type queries into a search bar and receive suggestions which are accurate, helpful, and easy to scan with minimal cognitive effort.

In one or more embodiments, a computer implemented method comprises providing an input device having at least one processor and a graphical user interface (GUI) displaying a search input area. The method further comprises receiving a search query from a user of the input device; determining, with the at least one processor, at least one search element to display on the GUI; requesting, from a server, two or more lists of search suggestions; displaying, on the GUI, the two or more lists of search suggestions to the user as the user enters the search query; and detecting, with the at least one processor, a user interaction with one of the two or more lists of search suggestions.

In one aspect, the search query includes characters entered by the user into the search input area, the characters being displayed on the GUI.

In another aspect, the input device includes a keyboard. When the user presses a designated key on the keyboard to complete the search query, the user is directed to a search results page associated with the search query received from the user.

In another aspect, the two or more lists of search suggestions each include one or more search elements related to the search query and are displayed simultaneously as the search query is received from the user.

In another aspect, the user interaction with one of the two or more lists of search suggestions is detected by highlighting one search element on a first list of the two or more lists of search suggestions.

In another aspect, upon detecting the highlighting of a search element on the first list, a second list of the two or more lists of search suggestions is at least one of updated, modified, or removed by the input device.

In another aspect, the at least one processor includes a search suggestion processor configured to receive the search query from the user and detect highlighting of a search element.

In another aspect, the two or more lists of search suggestions includes a first list of search suggestions displayed in a horizontal row above a search bar of the input device and a second list of search suggestions displayed in a vertical row under the search bar.

In another aspect, search elements on the horizontal list of suggestions are each represented by an icon or correspond to an associated domain.

In another aspect, the two or more lists of search suggestions includes a first list of search suggestions which includes one or more search elements representing domains, and a second list of search suggestions which includes one or more search elements representing web pages within a domain highlighted on the first list of search suggestions.

In another aspect, the two or more lists of search suggestions includes a first list of search suggestions which includes search elements representing web pages within a domain and a second list of search suggestions which includes search elements representing at least one domain associated with the search query. The first list of search suggestions is displayed in a horizontal row above a search bar of the input device and the second list of search suggestions is displayed in a vertical row under the search bar.

In another aspect, an interaction with a search element of at least one of the first and second lists is detected by a user input detector.

In another aspect, when a search element representing a domain is selected, the user is directed to the domain associated with the selected search element. When a search element representing a web page within a domain is selected, the user is directed to the web page.

In one or more embodiments, a computer-implemented method, comprises: providing an input device having a graphical user interface (GUI) and a search bar. The input device is configured to allow a user to type a search query into the search bar. The method further comprises receiving the search query from the user and providing and displaying a search suggestion list to the user on a first portion of the GUI as the user types the search query. The search query including one or more search elements each associated with a website. The method further comprises highlighting, with the user input device, a search element from the one or more search elements; displaying content from a webpage of the website on a second portion of the GUI; engaging, with the user input device, the highlighted search element; and directing the user to a uniform resource locator (URL) associated with the highlighted search result.

In one aspect, the displayed content from the website includes at least one of: a screenshot of a portion of the webpage that corresponds to the search query; a screenshot of the webpage that includes a visual overlay over a portion of the webpage that corresponds to the search query; a live feed of the webpage; and a textual description of the webpage.

In one or more embodiments, a computer-implemented method for ranking web-based search results comprises providing an input device having a graphical user interface (GUI) and a search bar. The input device is configured to allow a user to type a search query into the search bar. The method further comprises: receiving the search query from the user; generating a list of search elements based on the received search query, each search element being associated with a website; detecting whether the user has highlighted a search element from the generated list, the user highlighting the search element with the input device; displaying the generated list of search elements on a portion of the GUI; displaying content associated with the website of the highlighted search result on a portion of the GUI; detecting at least one user input indicative of an upvote of the highlighted search element, and; recording how many upvotes and downvotes the highlighted search element receives.

In one aspect, the highlighted search element is ranked in the generated list based how many upvotes and downvotes the highlighted search element receives.

In another aspect, a greater number of upvotes correlates to a higher ranking of the highlighted search term within the generated list.

In another aspect, the input device has a keyboard configured to allow the user to highlight the search element.

In another aspect, the input device has a processor configured to detect user input from the keyboard.

The above, as well as additional features and benefits of one or more embodiments of the present invention will be described below in more detail.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof that are illustrated in the appended drawings. It should be noted that the figures are not drawn to scale, and that elements of similar structure or function are generally represented by reference numerals for illustrative purposes throughout the figures. Understanding that these drawings depict only typical embodiments of the invention and are not therefore to be considered to be limiting of its scope, the invention will be described and explained with additional specificity and detail through the use of the accompanying drawings.

FIG. 1 illustrates a schematic diagram of a search environment in which the methods and systems disclosed herein may be implemented in accordance with the principles of the present invention;

FIG. 2 illustrates a schematic diagram of an electronic search system in accordance with the principles of the present invention;

FIG. 3A illustrates an electronic search user interface in accordance with the principles of the present invention;

FIG. 3B illustrates an electronic search user interface with an example search element in accordance with the principles of the present invention;

FIG. 3C illustrates an electronic search user interface with an example configuration of the search element of FIG. 3B in accordance with the principles of the present invention;

FIG. 3D illustrates an electronic search user interface with a further example configuration of the search element of FIG. 3B in accordance with the principles of the present invention;

FIG. 3E illustrates an electronic search user interface with a further example configuration of the search element of FIG. 3B in accordance with the principles of the present invention;

FIG. 4A illustrates an electronic search user interface with a further example configuration of the search element of FIG. 3B in accordance with the principles of the present invention;

FIG. 4B illustrates an electronic search user interface with a further example configuration of the search element of FIG. 3B in accordance with the principles of the present invention;

FIG. 4C illustrates an electronic search user interface with an example configuration of a received search element of FIG. 3B in accordance with the principles of the present invention;

FIG. 5A illustrates a method of providing a two lists system in accordance with the principles of the present invention;

FIG. 5B illustrates a method of providing visual results system in accordance with the principles of the present invention;

FIG. 6 illustrates of method of providing a visual voting system in accordance with the principles of the present invention;

FIG. 7 illustrates a block diagram of a computing device in accordance with the principles of the present invention; and

FIG. 8 illustrates a network environment of a search suggestion system in accordance with the principles of the present invention.

### DETAILED DESCRIPTION

The following description of embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

As used herein, an electronic search element (or simply “search element”) refers to any part of an electronic search system that allows a user to search the web using a graphical interface. (e.g., a computer or smartphone). For example, search elements can comprise one or more icons, buttons, text, links to particular URLs, and/or other content that can be selected by a user. For instance, a search element may comprise only an icon. In another instance, however, a single search suggestion may comprise one or more icons, an animation, and a button. In addition, search suggestions can comprise of both conventional written language, as well as one or more other elements. As used herein, a search suggestions list refers to a collection of search elements which is displayed on a graphical interface in response to a user's search query before the user signifies intent to end the input of the search query.

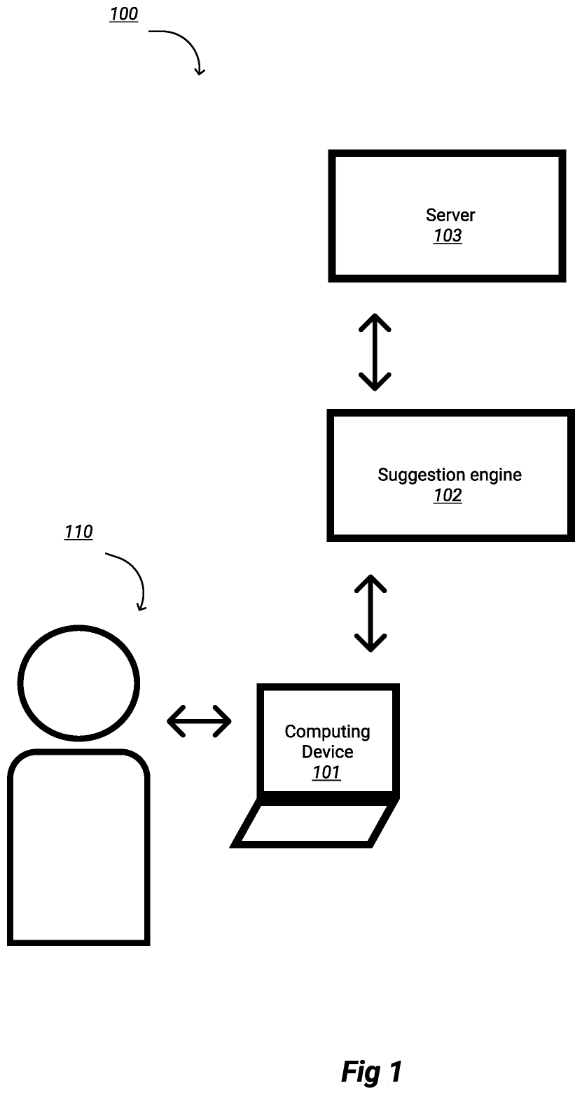

FIG. 1 is a schematic diagram illustrating an example system 100, within which one or more embodiments of an electronic search system (or simply “search system”) can be implemented. As illustrated in FIG. 1, system 100 can include: a computing device 101 such as a mobile phone, a laptop, a desktop, an AR or VR headset, or other computing device which the user may interface with and enter search queries; a suggestion engine 102 which may provide the logic of which search suggestion lists and which search elements to request from a server; and a server 103 which may store search suggestions and search elements. The computing devices 101, the suggestion engine 102, and the server 103 may be communicatively coupled, as shown in FIG. 1. Although FIG. 1 illustrates a particular arrangement of the computing devices 101, the suggestion engine 102, and the server 103, various additional arrangements are possible. For example, the computing devices 101 may directly communicate with the server 103, bypassing the suggestion engine 102. Alternatively, the computing devices 101 may communicate with external APIs, or data on a device, such as browsing history data.

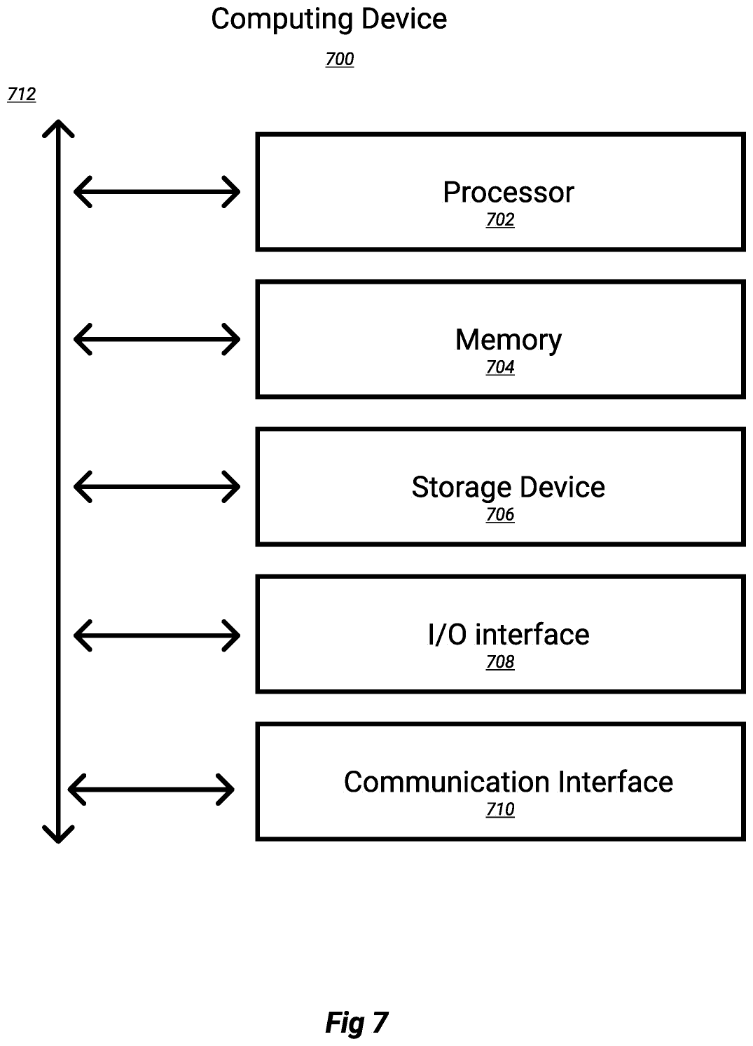

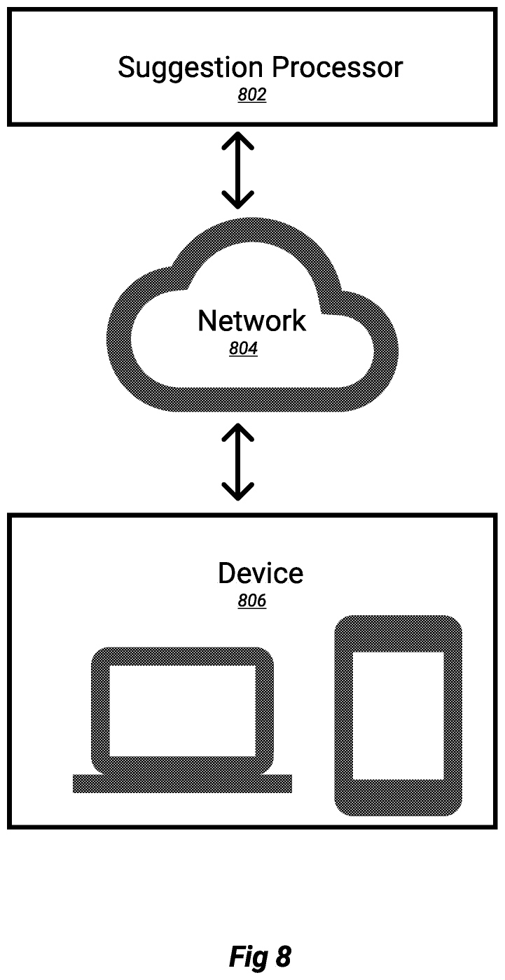

The computing device 101, the suggestion engine 102, and the server 103 may communicate using any communication platforms and technologies suitable for transporting data and/or communication signals, including any known communication technologies, devices, media, and protocols supportive of remote data communications, examples of which will be described in more detail below with respect to FIGS. 7-8. In addition, in certain embodiments, computing devices 101 and server 103 may communicate via the suggestion engine 102, which may include one or more suggestion modalities as described further below with respect to FIGS. 7-8.

Server 103 may generate, store, receive, and transmit electronic communication data. For example, server 103 may store suggestion data, send electronic suggestions to the computing device 101, or receive electronic search inputs made on the computing device 101, or receive requests from the suggestion engine 102. In particular, the server 103 can transmit electronic suggestions to one or more users of the system 100. In one example, server 103 can host a number of web page suggestions or query suggestions. In another example, the server 103 may include a MySQL database and an API which provides endpoints for the front end to connect with. Regardless, server 103 can be configured to receive a wide range of query types, and make recommendations including but not limited to, plain text query recommendations, web domain recommendations that may or may not include an icon to represent each domain, web page recommendations, open browser tab recommendations, API recommendations, screenshots of websites, paid advertisements, and any other form of an electronic suggestions or results. Additional details regarding server 103 will be discussed below with respect to FIGS. 7-8.

In addition to the system and search suggestions elements of system 100, FIG. 1 illustrates that a user 110 can be associated with the computing device 101. For example, user 110 may be an individual (i.e., human users). Although FIG. 1 illustrates only one user 110 it is to be understood that system 100 can include additional users, with each of the users interacting with the system 100 through a corresponding number of computing devices. For example, the user 110 can interact with the computing device 101 for the purpose of searching the web. The user 110 may interact with the computing device 101 by way of a user interface, coupled with an input device such as a keyboard, touchscreen, or mouse, on the computing device 101. For example, the user 110 can utilize the user interface to cause the computing device 101 to search the internet using the system 100.

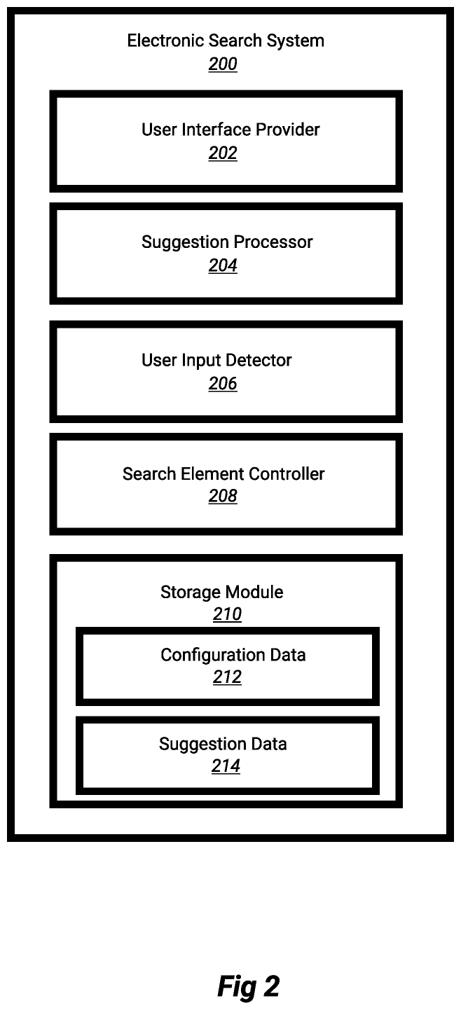

FIG. 2 illustrates an example embodiment of an electronic search system 200 (or simply “search system 200”) which provides a user with two lists of helpful search suggestions as a user searches the web. The system 200 can be implemented in whole or in part on computing device 101. As shown, search system 200 may include, but is not limited to, a user interface provider 202, a suggestions processor 204, a user input detector 206, a suggestions element controller 208, and a storage module 210. When the user input detector detects a search query from the user via the user input detector, it sends data to the suggestion processor which is programmed to receive data from a storage module and to determine, based on the query and other configuration data, which suggestion(s) to display, and to transmit data to the search element controller which, via the user interface provider, displays two sets of search query suggestions to the user. Each of the components 202-210 of the search system 200 may be in communication with one another using any suitable communication technologies. It will be recognized that although components 202-210 are shown to be separate in FIG. 2, any of components 101-110 may be combined into fewer components, such as into a single facility or module, or divided into more components as may serve a particular embodiment.

The components 202-210 can comprise software, hardware, or both. For example, the components 202-210 can comprise one or more instructions stored on a computer-readable storage medium, such as a memory, and executable by processors of one or more computing devices. When executed by the one or more processors, the computer-executable instructions of the search system 100 can cause a computing device 101 to perform the methods described herein. Alternatively, the components 202-210 can comprise hardware, such as a special purpose processing device to perform a certain function or group of functions. Additionally or alternatively, the components 202-210 can comprise a combination of computer-executable instructions and hardware.

As mentioned above, and as shown in FIG. 2, the search system 200 can include a user interface provider 202. The user interface provider 202 may be configured to provide, manage, and/or control a graphical user interface (“GUI” or “user interface”) that allows a user to search and select search suggestions using the electronic search system 200. For example, the user interface provider 202 can provide a user interface configured to facilitate internet search with helpful suggestions and display a search input area (e.g., search bar where text characters may be entered or inputted by a user of the input device).

More specifically, the user interface provider 202 may provide a display (e.g., a display screen associated with the computing device 101) through the use of the user interface, which may be composed of a plurality of graphical objects that facilitate electronic search. More particularly, the user interface provider 202 may direct a computing device 101 to display a group of graphical objects that enable viewing a search interface, wherein the user may type a query and receive one or more search suggestion lists, which include search elements, such as query recommendations, web page suggestions, or domain suggestions, for example. As used herein, “search elements” refers to any data or information, received as a recommendation from the system, to be included as part of an electronic search. For example, the term “search elements” will be used herein to generally describe, text, icons, URLs, page titles, domains, open tabs, buttons that allow a user to take an action such as, for example, making a purchase, and any other data that can be included as part of an electronic search. The search suggestions may be displayed on the user interface.

In addition, the user interface provider 202 may direct the computing device 101 to display a plurality of graphical objects that facilitate user input for searching the web. To illustrate, the user interface provider 202 may provide a user interface that allows a user to provide user input such as, for example, a search query, to the search system 200. For example, the user interface provider 202 can provide one or more user interfaces that allow a user to input the search query and receive search suggestions.

As discussed above, one particular example of content that can be included in an electronic search is a search element that is provided in two or more lists of search suggestions generated by the server. As described herein, a search element includes, but is not limited to, a search recommendation that may be helpful to a user, which when selected causes the browser to navigate to a search engine results page for that query recommendation. For example, if a user were to search the web and enter a typo in the search query, a suggestion might consist of a correction to the typo. Or, in another example, if a user enters a query where the intent is to know the weather, a suggestion might consist of the five-day forecast. In another example, a search element may be a search result which is associated with a web page which is relevant to the search query. In another example, a search element may include a buy button which, when selected, may purchase an item related to the search query. The user interface provider 202 can provide a user interface to allow a user to easily and efficiently select a search element from one or more lists of search suggestions. For example, the user interface provider 202 can provide one or more selectable lists of search suggestions with which a user can interact to make a selection of one or more search elements. In one or more embodiments, the user interface provider 202 can provide one or more selectable items, such as search elements, associated with the search query characters that the user has typed into the search bar which the user may then select. At least one processor, such as search suggestion processor (discussed below) is configured to allow the computing device 101 to detect a user interaction with at least one of the two or more lists of search suggestions.

User interface provider 202 can facilitate a presentation of context-sensitive search elements as the user types a query. In response to the search query, the search interface provider 202 may provide a user with two or more different sets of search suggestions simultaneously. Each search suggestion list may include one or more search elements related to the search query received from the user. In one embodiment, a computer-implemented method comprises receiving, at the client computer system 101, search suggestions responsive to a search query, wherein, in one embodiment, one or more search suggestions are displayed as a vertical list and one or more search suggestions are displayed in a horizontal list. In response to detecting a user interaction with one of these sets of search suggestions via the user input detector, the search interface provider 202 may provide a user with updates to, modifications to, or a replacement of, the second set of suggestions.

As mentioned above, and as illustrated in FIG. 2, the search system 200 may further include a search suggestion processor 204. The search suggestion processor 204 may include at least one data processor, or coder and decoder (codec). The suggestion processor 204 can facilitate predicting which kind of search suggestions list(s) is most likely to be useful to a user, by means of a software program, and to send a request to a server for that list. In one embodiment, the suggestions processor would then receive that list, and display it on a user interface provider 202. Additionally, the suggestions processor may be configured to algorithmically predict which search elements on the desired list of search suggestions are most likely to be helpful to a user, and to sort or filter the list of search elements based on predicting which search elements are most likely to be useful to a user.

In one embodiment, which may be referred to as domain search, the search suggestion processor 204 may detect a user input on a user input detector 206 signifying intent to search for a particular website. This can be helpful to users who are searching the web in order to visit a particular domain and are not in need of a search results page. This feature can be helpful in that it detects the user intent and allows the user to visit that domain directly from the search suggestions which show up as a user types a query, saving the user time. In this example, when a user types one or more characters of a particular domain name and sends a request for a search suggestions list containing domain names or company names, the search suggestion processor 204 may then, by executing at least one program stored at the memory, provide domain names which correspond with the characters which the user has typed, and then sort those domain names based on an algorithm which predicts which domain names are most likely to be useful to the user. If, however, the search suggestion processor 204 detects a user input indicating intent to search the web more generally, in one example, this can be by detecting a user engaging the spacebar (or any other programmed or designated key) on the keyboard indicating an interest to perform a longer query with more than one word, the search suggestion processor 204 may request a list of search results which are related to that particular search query. In one example, when the search suggestion processor 204 detects an input of a user pressing the spacebar key on a user input detector 206, the search suggestion processor then assumes that the user is no longer interested in domain names, but instead is interested in general search results, and therefore send a request to receive an alternative list of search suggestions which are better suited to satisfy the user, and then control the interface provider 202 to display the list of general search results instead of the list of domain results.

In particular, search suggestion processor 204 may be configured to receive a user input in selecting, or highlighting, using a user input detector 206, a search element from one of these lists of search suggestions, and in response, to provide updates to a second list of search suggestions on a user interface provider 202. The search suggestion processor 204 may further be configured to build and store a model of which suggestions the user is most likely to find helpful based on the general behavior of searchers, or on the particular history of that user, and to send and receive electronic data. For example, the search suggestion processor 204 can use a predictive model based on a user's browsing history, based on search elements that a user has “liked,” or indicated interest in in the past, based on other users within the system that have similar behavioral preferences, based on the current URL that the user is viewing in the browser, or other methods and means with which to make predictions. The search suggestion processor 204 might also determine which paid suggestions (e.g., advertisements) to recommend based on an ad bidding logic. An example of this bidding logic might be as follows: when ads are displayed to end users, the users will have the ability to like or dislike the ads, providing the system with feedback on which ads users enjoy. Ads which get many likes would see an increase to their bidding power. For example, if Nestle® bids $20, and PepsiCo® bids $50, but the Nestle® ad is liked by end-users, the Nestle ad would be displayed since the bidding power is a function of bid * how much the ad has been liked by end users.

Additionally, the search suggestion processor 204 may be configured to request or to provide screenshots of a particular website, in response to a user input highlighting a search element. For example, if a user is looking up vacations in Miami, Florida, the user is able to highlight an icon corresponding to visitmiami.com or another related website rather than having to press a designated key to select a link result and be navigated to a new webpage. When the visitmiami.com (or other website) icon is highlighted, the webpage of that site would be displayed on the user interface. When the user then highlights the next site by means of the user a keystroke, for example, the next site would be displayed on a user's device. This allows the user to quickly skip between results without clicking links to be directed to new webpages and then having to click additional options to return back to the original webpage. Critically, these icon results are displayed to the user at the same time as the list of search suggestions is displayed. Once these icons are highlighted, the list of search suggestions can be removed so that the user can get a full screen view of the websites.

According to one or more embodiments, the digital content from the webpages that is displayed to users may include at least one of screenshots from a portion of the webpage that corresponds to the search query entered by the user, screenshots of the webpage that include a visual overlay over a portion of the webpage that corresponds to the search query, a live feed of the webpage, and a textual description of the webpage.

Furthermore, the suggestion processor 204 can be configured to facilitate requesting content from sources outside of search system 200. To illustrate, upon a user interacting with a selectable item to select a search element to include in an electronic search, the suggestion processor 204 can request the selected search element (or configurations thereof) from a corresponding source of the search element. For example, the suggestion processor may request data from the Bing Search API, or the Clearbit API in order to provide helpful results for a query. Thus, the search suggestion processor 204 can be configured to request and receive search elements, or other content, for use within the search system 200 from sources inside or outside the search system 200.

As further illustrated in FIG. 2, the search system 200 includes a user input detector 206 such as, for example, a sensor. In one or more embodiments, the user input detector 206 can detect, receive, and/or facilitate user input in any suitable manner. In some examples, the user input detector 206 may be configured to detect one or more user interactions. As referred to herein, a “user interaction” means a single input, or combination of inputs, received from a user by way of one or more input devices.

For example, in one or more embodiments, the user input detector 206 may be configured to detect a user interaction (i.e., user input) from a keyboard, mouse, touch screen, or other similar input device. Additionally, in one or more embodiments, the user input detector 206 may also be configured to detect hand movement detection using lidar, light detection and ranging mapping to generate precise and directly georeferenced spatial information about the shape and surface characteristics of items, or a electromyography (EMG) detector on a wristband to interpret electrical activity from motor nerves as they send information from the brain to the hand, a foot pedal, or other mechanism, or any other input device. In the event a keyboard is utilized, the user input detector 206 may be configured to detect one or more keyboard strokes that form the user interaction (e.g., pressing right arrow key, tab key, down arrow key) provided by a user by way of a keyboard. In some examples, the detected keystrokes may be provided in relation to and/or directed at one or more items or elements of a user interface presented on the device 101.

The user input detector 206 may be additionally, or alternatively, configured to receive data representative of a user interaction. For example, user input detector 206 may receive one or more user configurable parameters from a user, one or more user commands from the user, and/or any other suitable user input. For example, the user input detector 206 might detect a user highlighting a search element with extra force on a touchscreen or highlighting a search element and leaving the search element highlighted for a given period of time.

User input and other data received by user input detector 206 may be utilized by search system 200 to manage, control, and/or facilitate the use and navigation of a user interface. For example, in response to one or more keyboard strokes detected by user input detector 206, search system 200 may display search suggestions on the user interface provider 202 and allow a user to make one or more selections of search elements. For example, in response to one or more keyboard strokes detected by the user input detector 206, search system 200 may allow a user to highlight a search element by marking it with a visual indication signifying an interest in the search element. In one example, after a user searches “A” in the search bar, the logos of Amazon®, and Alibaba® are displayed above the search bar, and a user may hit the right arrow key to select Amazon®, and then hit it again to highlight Alibaba®, or, a user might then select a search element by hitting the enter key on the keyboard. Critically, this can happen before the user types enter to signify a desire to end the input of the search query and visit a search results page.

As described herein, the present invention is not limited to the specified keystrokes. The keystrokes specified herein are merely for exemplary purposes and it should be understood that a keyboard or other input device could be programmed and/or configured by a user to execute the same processing functions and/or operations using different keystrokes or a combination of keystrokes.

In one embodiment, when the user input detector 206 detects a character being entered or otherwise inputted using the input device 302, the computing device 101 may send this character to the suggestion processor 102. The suggestion processor 102, which is in wired and/or wireless communication with a server 103 or external source, may then request a list of search suggestions from the server 103 or the external source, such as an API, and cause the user interface provider 202 to display this list of suggestions which may include one or more search elements which may represent one or more web pages which are relevant to the query which has been imputed on the user input device 302. For example, if a user were to highlight the New York Times icon which is displayed above the search bar, underneath the search bar, a user might be able to see a number of most recent articles from the New York Times®. These articles may be obtained from an API which the New York Times makes available. In another example, if a user is trying to navigate to a Zoom® meeting which is associated with the user's account, then when a user types the Z key into the keyboard, above the search bar a user might see the Zoom® logo, and under the search bar, a user might see a list of upcoming meetings, which when selected would cause the browser to navigate to that meeting. When an additional character input is detected by means of the user input detector 206, the search suggestion processor 204 may again initiate a request from a server 103 for search elements, such as search results, and cause the user interface provider 202 to display the updated list of search elements on the user interface.

For example, a user might type “how to tie a knot”, and in response receive a number of search results related to that query, before the user signifies intent to end the search. If the user sees a result which may be beneficial, the user may select that result. If the user continues the query, and types “how to tie a knot tight”, the results for that query would be displayed even before a user would complete the search query by typing “how to tie a knot tightly”. This can be helpful to users since often there would be useful results which explain how to tie a knot tightly even if the user has just queried “how to tie a knot”.

As referred to herein, “highlight” means a single input, or combination of inputs, received from a user by way of one or more input devices signifying intent or interest in a particular graphical element while not signifying that the user would like to “click on” or navigate to the URL which that graphical element maps to. When an element is highlighted, the graphical interface 202 would signify that a graphical element is highlighted by showing a visual change in that graphical element.

In addition, in FIG. 2 illustrates that the search system 200 can include a search element controller 208. In one or more embodiments of the present invention, the search element controller 208 configures a search element to be included in the search suggestions. For example, based on a user interaction detected by the user input detector 206, the search element controller 208 may make changes to a search suggestion list by modifying the search elements which are displayed in the list of search suggestions.

The search element controller 208 can configure the search elements by highlighting a search element such as a search suggestion. For example, in particular embodiments, to simplify navigation to a particular destination within a website, the search system 200 may provide a user with a number of domains on the user interface provider 202 in response to a search query via the user input detector 206. If the user then highlights one of these search elements which represent domain recommendations, the search suggestion processor 204 is configured to receive this highlighting input, and in response would provide the search element controller 208 with an additional set of search suggestions which include a number of search elements representing relevant web pages on that particular domain which may be of interest to the user.

To illustrate this further, in one or more embodiments, upon detecting a search query via a user input detector 206, the suggestion processor 204 may request from one or more servers 103 or one or more external sources of data, two separate lists of search suggestions. These two lists of search suggestions may be referred to as list A and list B. The search suggestion processor may be configured to then display these two lists on the user interface provider 202 using the search element controller 208. When the suggestion engine further receives, via the user input detector 206 an input signifying intent to highlight a particular search element on list A, the search suggestion engine 204 may be configured to request a new list of search suggestions. This new list of search suggestions may be referred to as list C. The search suggestion engine 204 may then replace list B with list C, by displaying list C instead of list B on the display device 101, using the interface provider 202, since list C is relevant to the search element which the user has highlighted on list A. The computing device 101 would then display list A and list C. The search system 200 may then further detect an input from the user via the user input detector 206 signifying intent to highlight a search element on list C. As described below, this particular system can be quite helpful to users.

In one further embodiment, the search system is further configured to request, when detecting a highlighting of a search element on list C via the user input detector, a new list of search suggestions. This new list may be referred to as list D. The search suggestion engine 204 may then replace list A with list D, by displaying list D instead of list A, using the interface provider 202, since list D is relevant to the search element which the user has highlighted on list C. The display device 101 would then display list C and list D.

In one embodiment, the search suggestion processor 204 receives an input from a user using the user input detector 206 to initiate a search for information on the Internet. The search suggestion processor 204 identifies, based on the search query performed at least one domain name (e.g., www.amazon.com) that is related to the search query (e.g., “ama”). In one example, this is a company name which begins with the character(s) which the user has typed. The user interface provider 202 may then display, for example, an icon, or multiple icons representing that website, above the search bar of the computing device 101 in response to identifying at least one domain name (e.g., www.amazon.com) related to the search query (e.g. “ama”). The user may select one of these icons, using the search element controller 208. In alternative embodiment, once a user types a query, then by default the best matching icon may be highlighted without an additional user input. The search suggestion processor 204 then queries a database, or external source, comprising data related to the domain which is highlighted, and retrieves one or more search elements that match that particular internet domain (e.g., www.amazon.com/shoes, www.amazon.com/clothing, www.amazon.com/furniture). The user interface provider 202 then displays the list of search suggestions that match the internet domain which has been highlighted; in one embodiment, under the search bar.

In one embodiment, the user may then highlight one of the search suggestions (e.g., www.amazon.com/shoes) using the search element controller 208. For example, by using the right arrow key of the keyboard, an example of interface device 302, a user might highlight or select an icon displayed above the search bar in a horizontal row of suggestions to represent different domains, while using the down arrow key, the user might highlight or select a text suggestion in a vertical list of suggestions under the search bar meant to represent different web pages on that domain on the user interface provider 202. Pressing the enter key can cause the user to be redirected to the highlighted search suggestion upon selection.

As discussed above, the search system 200 can include a storage module 210, as illustrated in FIG. 2. Storage module 210 may maintain configuration data 212 representative of data used in connection with search queries which users perform. For example, configuration data 212 can include a user's search history or browsing history, search logs, selections, queries, and other similar type data that the search system 200 may use in connection with providing the ability for users to electronically search.

Storage module 210 may also maintain suggestion data 214 representative of information used to configure one or more search elements. For example, suggestion data 214 may include data that maps the search elements of multiple search suggestion lists to each other. For example, suggestion data may include search results for a particular query, screenshots of web pages, one or more suggested web pages for a given domain, or data that would allow the client device to display search related elements.

As will be described in more detail below, each of the components 202-210 can be used alone and/or in combination with the other components of the search system 200 to provide a search element to be included in an electronic search. In particular, the components 202-210 allow a user to perform a search query, to receive multiple lists of suggestions, to select or highlight a search element from the list of suggestions, and to then receive an updated search element, such as an additional or updated list of search suggestions, based on that selection or highlighting.

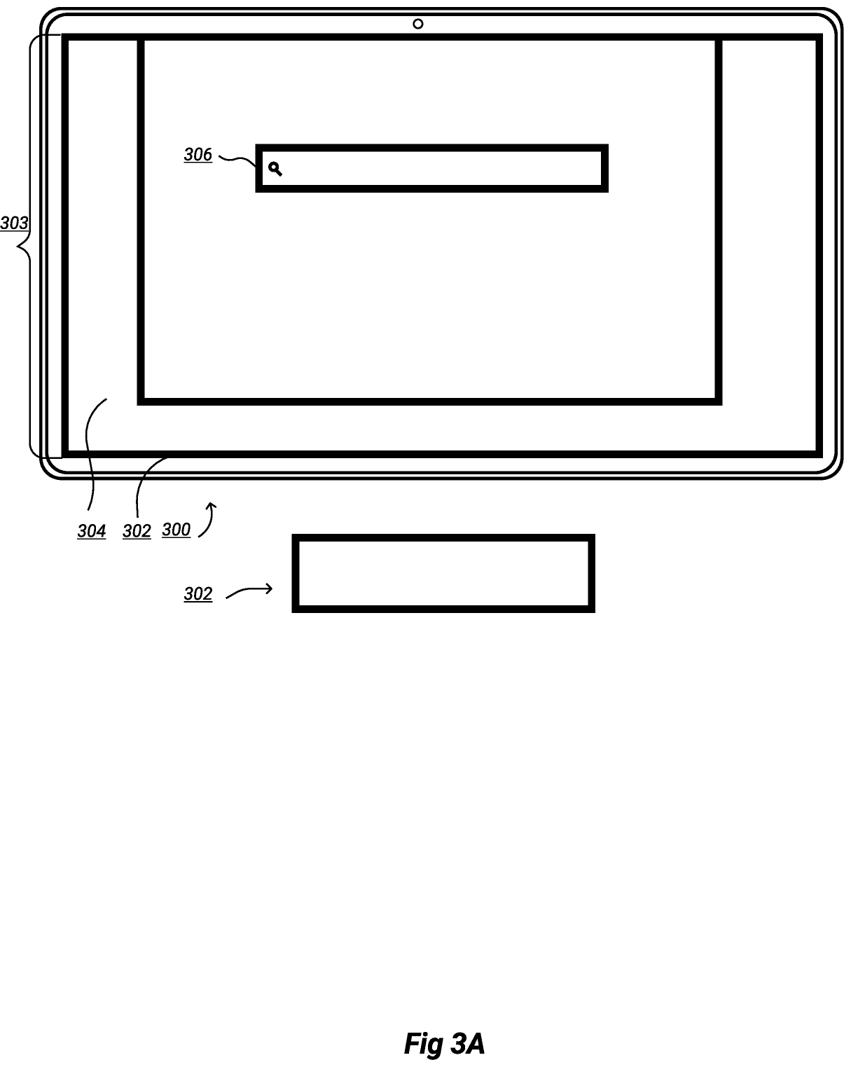

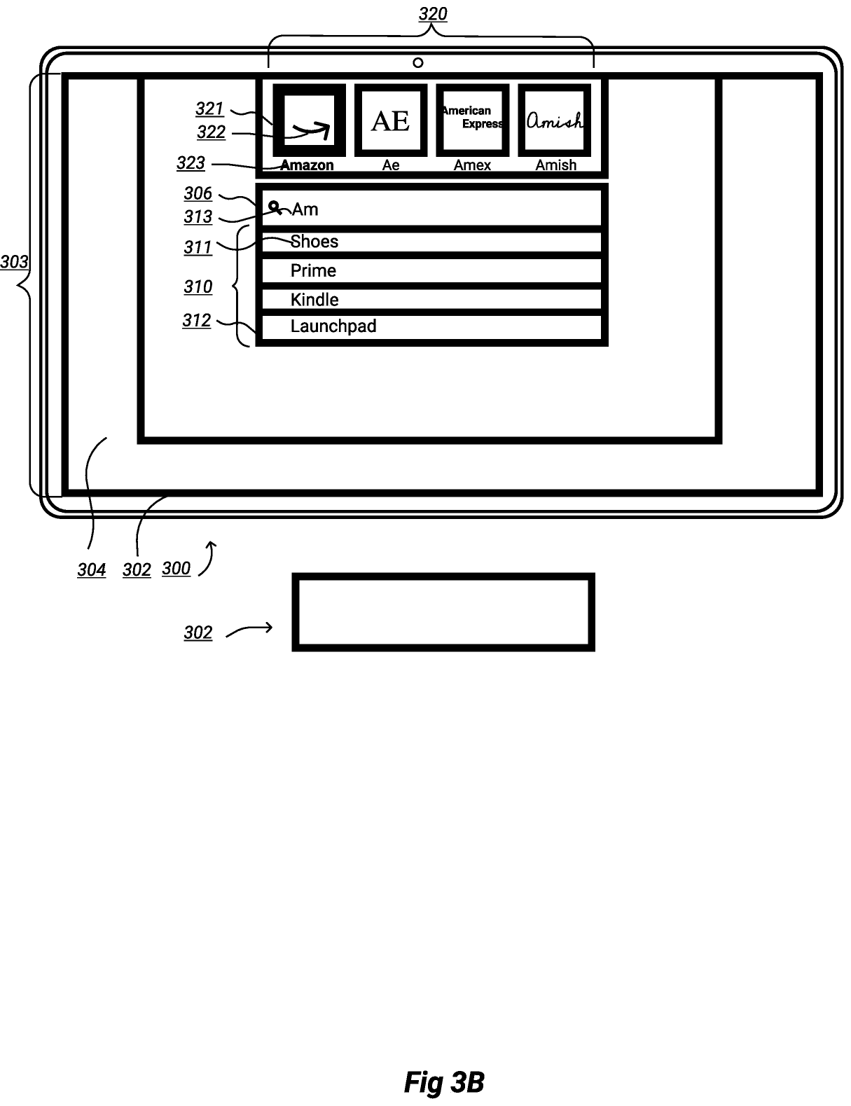

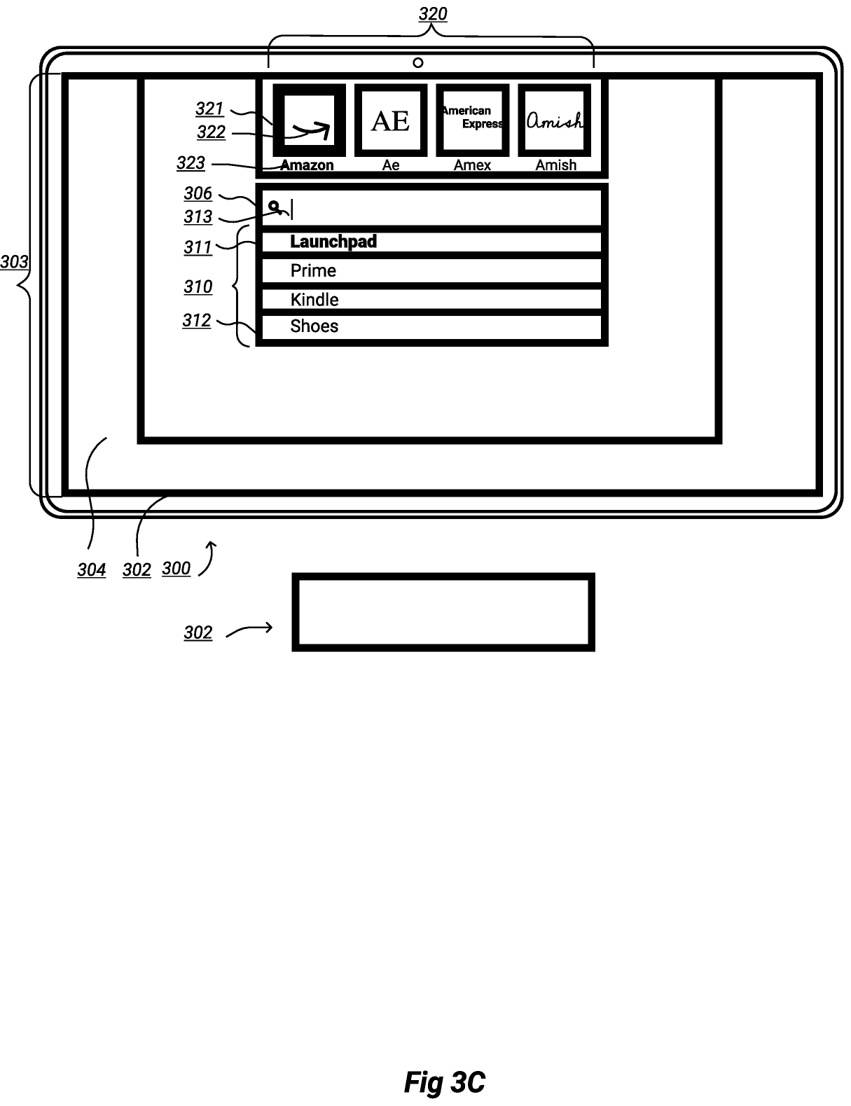

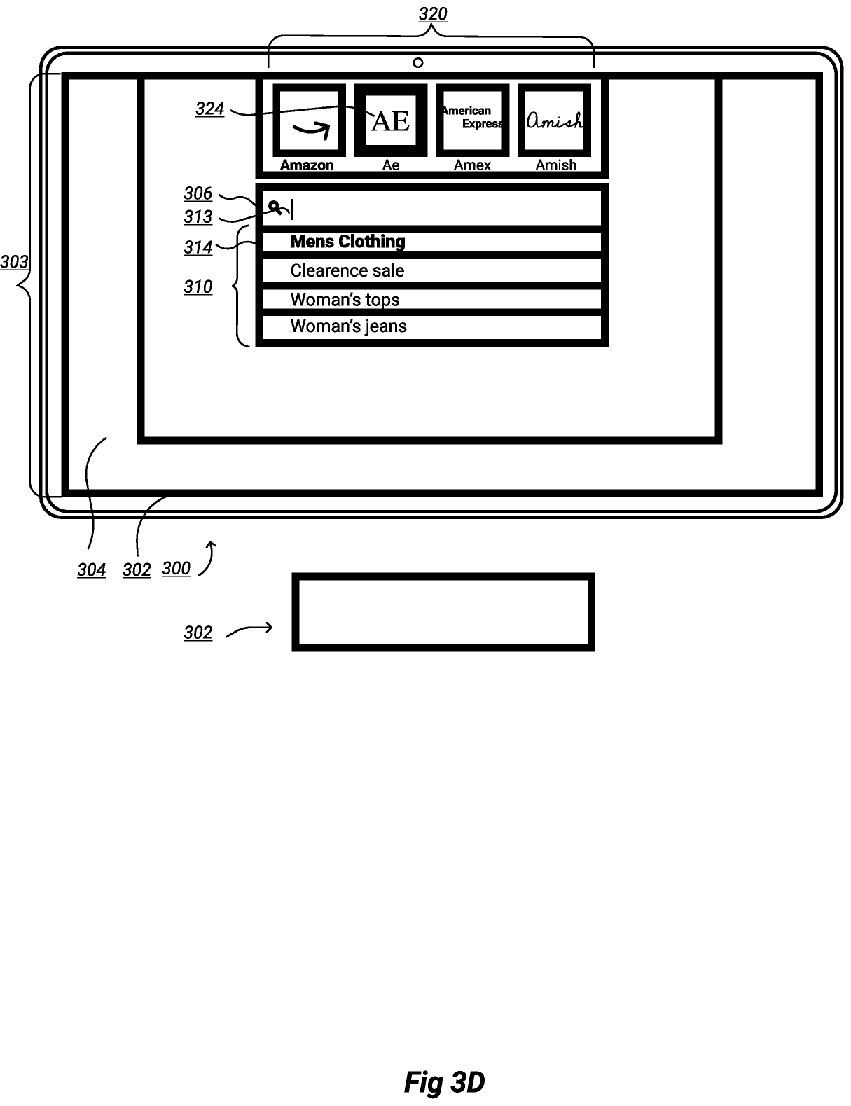

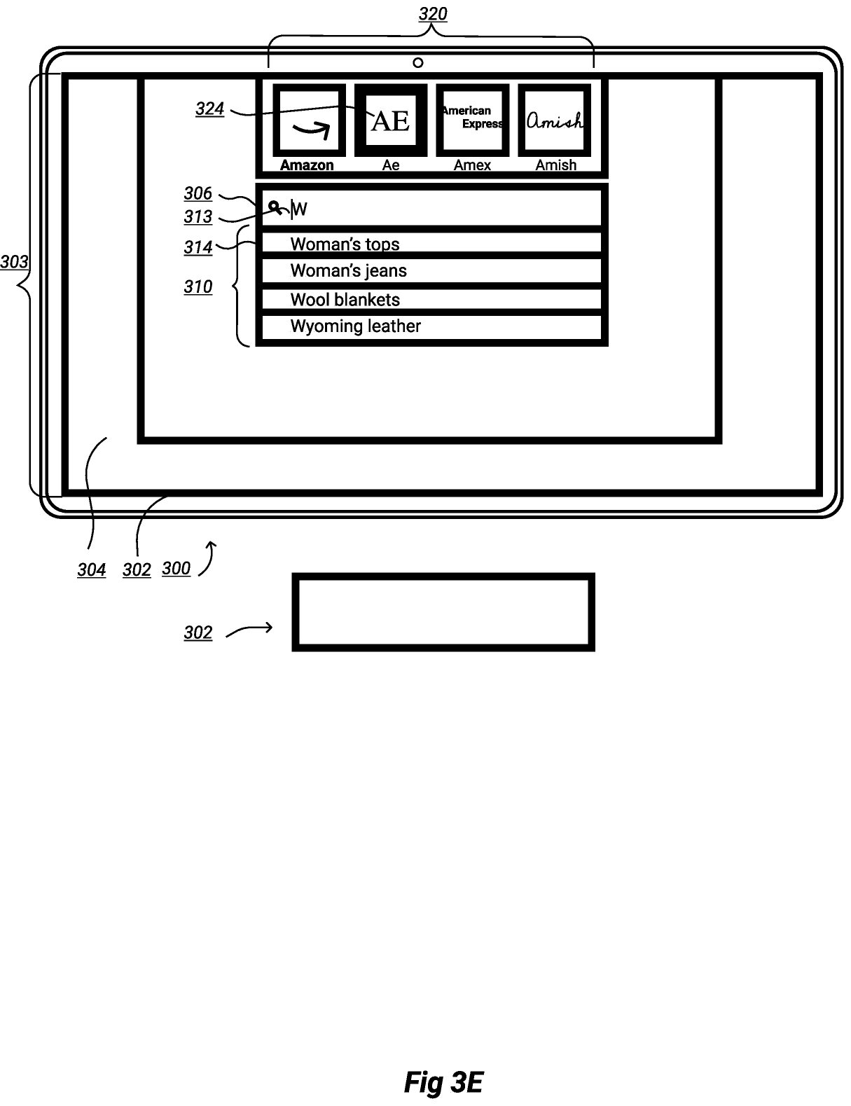

In some examples, system 200 may be implemented partially or entirely on a computing device (e.g., computing devices 101, 104). For example, FIG. 3A illustrates a computing device 300 that may implement one or more of components 202-214. For example, computing device 300 may perform one or more operations associated with the presentation, processing, and/or management of an electronic search system as described herein.

As illustrated in FIG. 3A, computing device 300 is a computer device (e.g., a laptop). However, in additional or alternative examples, system 200 may be implemented by any other suitable computing device, such as, but not limited to, a tablet device, a handheld device, a desktop computer, a smartphone, an AR or VR environment, a personal-digital assistant device, and/or any other suitable computing device configured to perform one or more of the processes and/or operations described herein. As illustrated in FIG. 3A, computing device 300 may include and/or be associated with a user input device 302 by way of which user input may be received and/or detected. Additionally or alternatively, computing device 300 may include any other suitable input device (e.g., one or more input buttons or a touch screen, a foot pedal, an eye tracking device, an interaction with a smartphone coupled with device 300, a hand tracking wearable device, or a lidar motion detector).

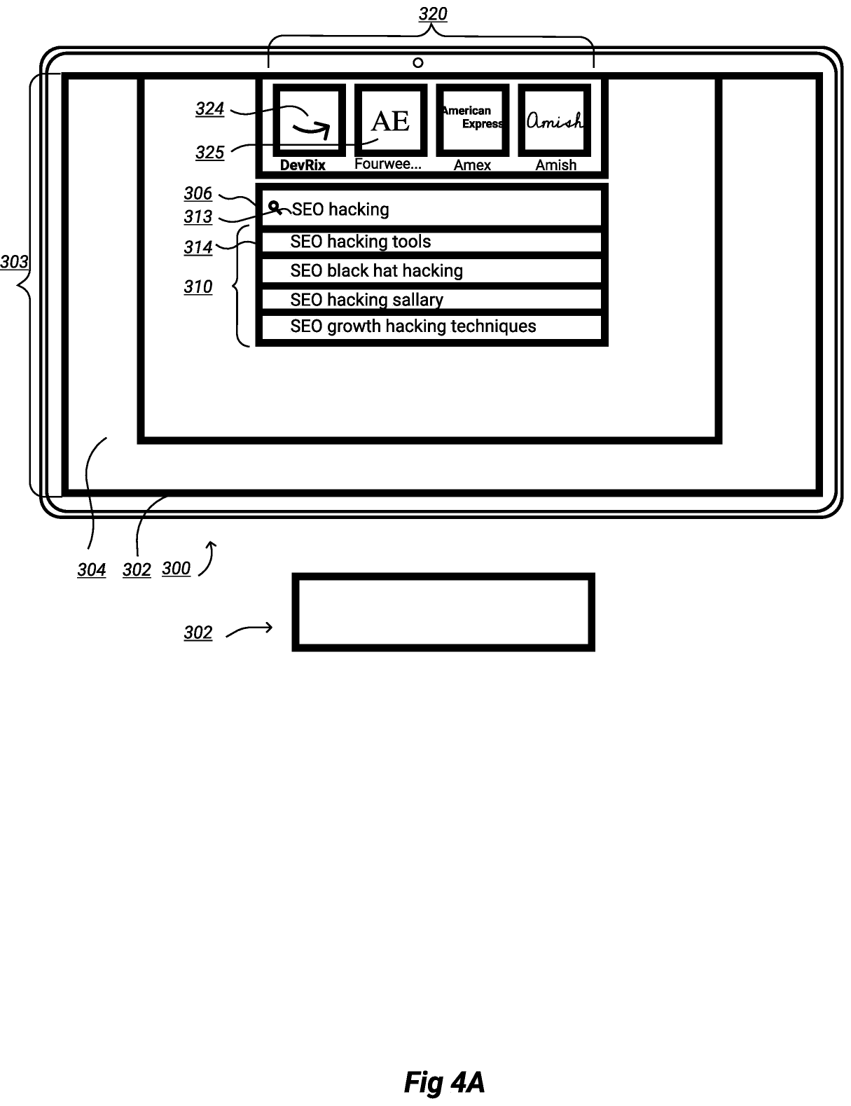

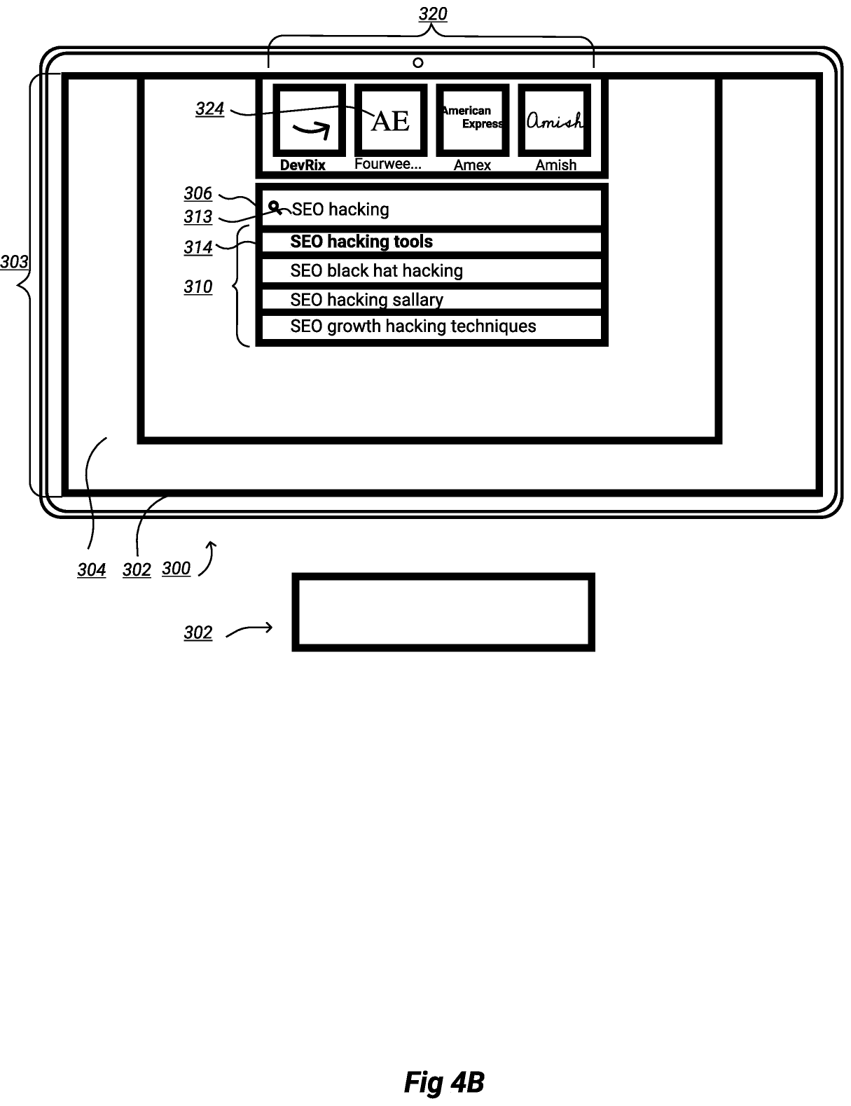

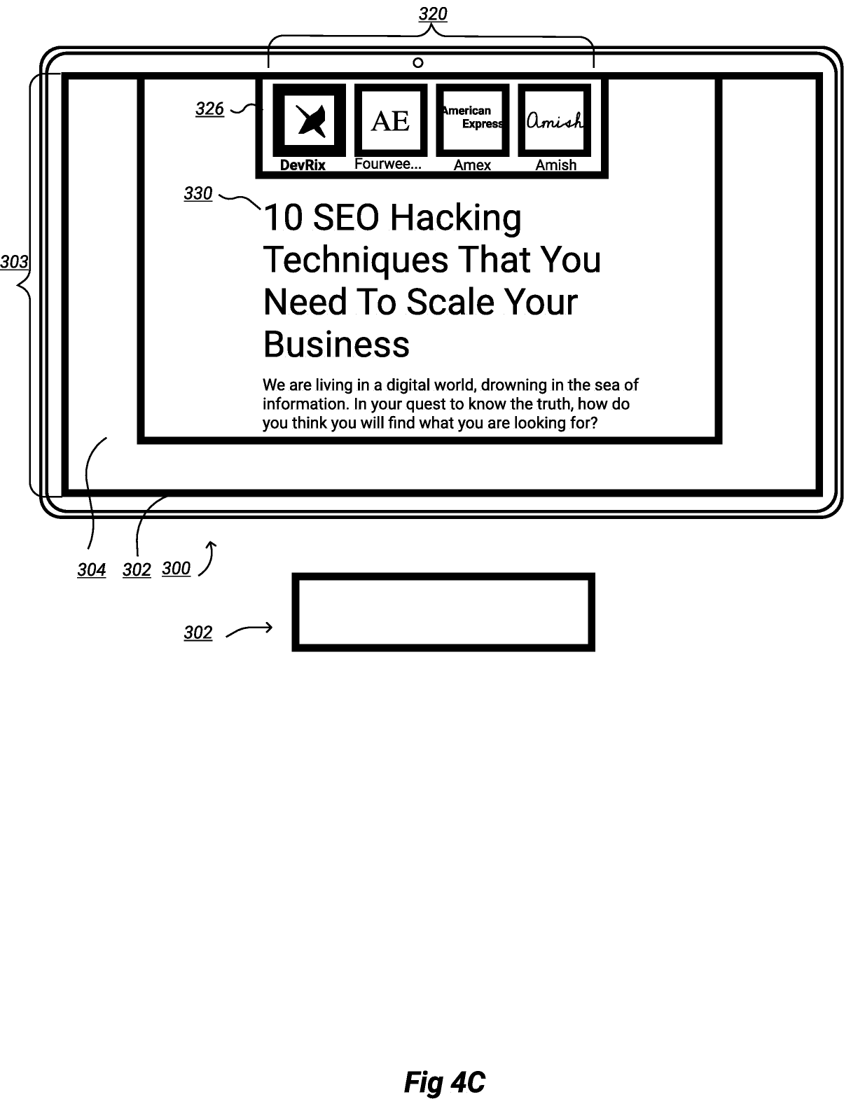

Regardless of the computing device 300 characteristics, the electronic search system 200 can be implemented using a variety of systems and methods. FIGS. 3A-4E illustrate example embodiments of a user interface that allows a user to query, highlight, and select search elements within an electronic search using the principles described herein. As illustrated in FIG. 3A, the screen 303 can present a user interface 303 that includes a viewing area 304. In general, the viewing area 304 is the portion of the user interface 303 that facilitates the display of electronic search elements.

The viewing area 304 can have various formats and characteristics. For example, and as illustrated in FIG. 3A, the viewing area 304 is configured to include a search interface. In other words, the viewing area 304 displays an input area, such as a search bar input field 306, and in some cases, even before a user begins to type a query, a number of search suggestions.

FIG. 3B illustrates the viewing area once a user has begun to type a search query. Viewing area 304 includes an input field 306 and a list of suggestions 310 which includes a number of search elements 311. In this case, the viewing area 304 presents the most relevant search element 311 at the top of the suggestion list 310, and less relevant search elements 312 towards the bottom of the suggestion list 312. Additionally, the display area may display a second list of search suggestions 320 above the search bar, which includes a number of search elements 321, in this embodiment each represented by an icon 322 and a title 323 with the most relevant search elements being presented further to the left.

As mentioned above, the user interface 303 includes an input bar 306, which provides an interface to allow a user to provide user input to compose a search query using the input device 302. The input bar 314 may include a text input area 306 that facilitates text input The user interface 303 may include various features which are presented to the user which are relevant to the query. For example, if a user would like to access a page on Amazon.com, a well-known e-commerce monopoly website, and as illustrated in FIG. 3B, the user interface 303 can present a list of search suggestions in response to a user beginning to input a search query 313 such as “am,” in this example.

FIG. 3B further illustrates that one search element 321 from the horizontal list of search suggestions 320 is highlighted. Once a search element is highlighted, the user interface may represent that search element in a color, shade, or shape that is different from the rest of the search elements in the list of search suggestions.

In some scenarios, the user interface 303 may highlight the first search element 321 by default, while in other scenarios, the user interface 303 may only highlight a search element 321 once it detects a user input indicating interest in the search element from a user input device 302. In one embodiment, the user input to indicate interest in a search element from the horizontal list 320 would be the right arrow key on the keyboard or the tab key. The user may then indicate interest in selecting the highlighted search element 321 from the horizontal row of suggestions using the input device 302, in some embodiments by pressing the enter key, to visit a web domain represented by that search element.

FIG. 3C illustrates a scenario in which a user desires a search element 311 from the vertical list of suggestions 310 which was suggested based on the highlighting of a search element 321 from the horizontal list of suggestions 320. In the illustrated example, a user has entered a query with the letters “am” in the search bar 306 using the input device 302. The user interface then displayed a horizontal row of search suggestions 320, each representing a domain related to that query above the search bar, including a search element from amazon.com 321. Once amazon.com has been highlighted, the user interface then displays a number of search suggestions as a vertical list 310 under the search bar, including 311 search elements representing a variety of web pages on the domain amazon.com. For example, included in that list of suggestions is Prime and Kindle, two pages on the domain amazon.com If the search system detects a user input indicating interest in a search element from the vertical list from the input device 302, then the user interface would highlight a search element 311 from the vertical list of suggestions. Once a search element is highlighted, the user interface may represent the highlighted search element in a color, shade, or shape that is different from the rest of the search elements in the list of search suggestions. In the illustrated example, Amazon Launchpad is highlighted, and is displayed in a bold type to represent the highlighting. If the search system detects a user input indicating a desire to select the highlighted search element from the input device 302, the browser would then navigate to that URL, and the user interface would then display the web page represented by that search element.

FIG. 3D illustrates a scenario in which the search system 300 detects a further input on input device 302 indicating interest in a second search element 324 from the horizontal list of search suggestions 320. In that scenario, the user interface would then display updates to the list of vertical search suggestions 310 providing the user with a number of web pages related to the highlighted search element 324. In the illustrated example, a second search element 324 American Eagle (Ae) has been highlighted by the user, and a list of vertical suggestions 310, including a web page about a clearance sale, and a web page that sells women's jeans have been displayed on the user interface 303.

If the search system detects a user input indicating a desire to highlight a search element from the input device 302, the user interface 303 would then display that search element to be highlighted 314. If the search system detects a user input indicating a desire to select that search element, the browser would then navigate to that URL, and the user interface 303 would then display the web page represented by that search element.

FIG. 3D further illustrates a scenario in which the search system detects a user input for any domain from the horizontal list of search suggestions 320, and then detects a user input indicating a design to highlight a search element from the horizontal list of search suggestions 310. In this scenario, the user has clearly indicated an interest in a given domain, and the search query characters are no longer needed for domain selection. Hence the user interface may clear the search bar 306 and the user interface 303 may display a typing input indicator, indicating that the user may input an additional query to search within that given domain. If the search system then detects a further input on input device 302, the user interface may display only search elements which are related to or match that additional query. FIG. 4A illustrates how when a user types the letter “W”, for example, using the input device 302, the user interface 303 only displays search elements related to that query. In this example, that includes “Women's jeans.”

FIG. 4B illustrates an embodiment of this invention in which a user does not have a specific website in mind when the user does a query. For example, when a user is doing research, often it isn't clear which website will provide the best answers. In the illustrated example, the user desires to learn more about “seo hacking”. In this scenario, the user interface 303 displays a vertical search suggestions list 310 which includes one or more search elements 314 which contain query recommendations related to the query that the user is typing and a second list of search suggestions which include search results above the search bar. In the illustrated example, the search system recommends queries such as “seo black hat hacking”. If the search system detects a user input indicating a desire to select the highlighted search element (i.e. a query recommendation) from the input device 302, the browser would then navigate to a results page (i.e. SERP) for the selected search query. The search suggestion processor 204 may obtain this list of search suggestions from a third party API, such as the Bing Autosuggest API, or through a separate data management and recommendation engine system which is stored on a server device.

FIG. 4C illustrates a situation where in this scenario, the user interface 303 may also display a search suggestion list above the search bar 320 which may contain one or more search elements, representing web pages that are deemed relevant to the search query from around the web 326. Each of these elements may also include an icon or logo representing that web page 326. In the illustrated example, when the user inputs a query “SEO hacking”, the search suggestion list includes a result from DevRix, an SEO hacking website. This would replace the need for a SERP altogether in many cases.

If the user finds one of these search results compelling, the user may visit that page by selecting that icon without going to a SERP by pressing the enter key to indicate a completion of the search query. This allows users to find what they need without leaving the web page that they are in the middle of viewing. If the user would like to navigate to a SERP page, the user may press the enter key using the input device 320 and the user interface 303 would display a SERP for the query which was inputted. FIG. 4C illustrates a scenario in which the search system detects a user input indicating interest in a search element representing a relevant web page (i.e., search result) from this search suggestion list 320 from the input device 302, then the user interface would highlight a search element 326. If the search system then detects a user input indicating a selection of the highlighted search element, then the user interface may display that

FIG. 4C further illustrates that once a search element 326 representing a search result has been highlighted, the search system may hide the second list of search query suggestions 310 from the user interface 303 in order to give the user a full screen view of that particular result through a visual results system described below since once a user is interested in results, query suggestions won't be that useful. The search system may also hide the search bar 306 from the user interface 303.

FIG. 4C further illustrates that once a search element 326 representing a search result has been highlighted, the search system may display that web page 330, corresponding to that search element 326 representing a search result, while displaying the horizontal search suggestion list 320 which includes search elements 326 representing web pages relevant to the search query (i.e., search results).

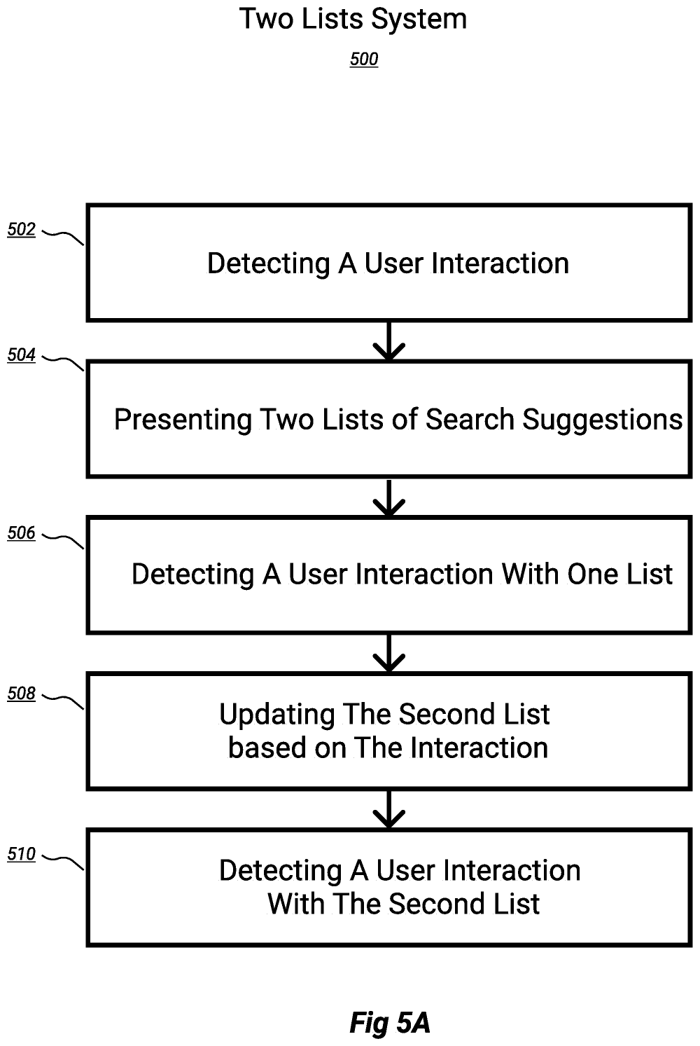

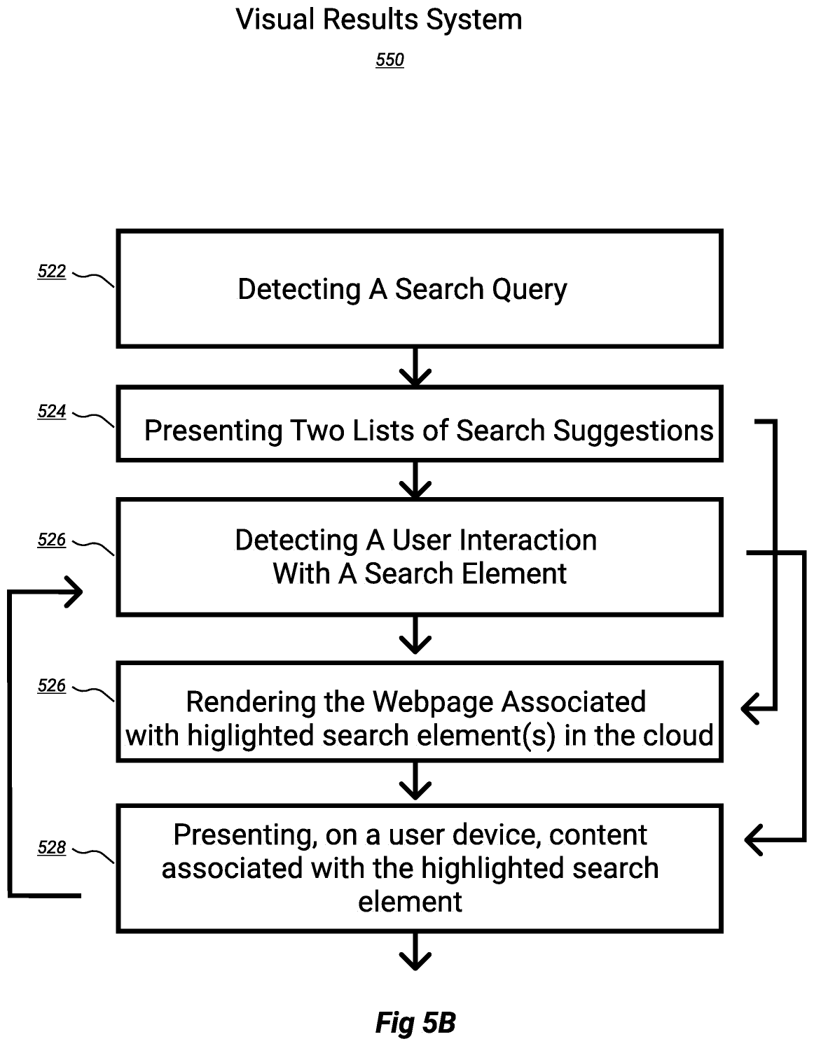

FIG. 5A illustrates a flowchart of this two list search recommendation system 500. First, a user performs a query, which is detected 502, and the system presents two search suggestion lists 504. Then, the system detects a user interaction with one list 506, and updates the other list based on that interaction 508. This system may then, in some cases, detect an additional interaction with the second list 510.

FIG. 5B illustrates a flowchart of a visual results system 550. In the visual results system, instead of users being presented with a number of links, and needing to pick one which fits them, the system allows users to quickly flip between all of the results using an input device. The graphical user interface 303 displays the search elements 320 on a portion of the screen, and content associated with a highlighted search element 330 on a second portion of the screen. The content associated with the highlighted search element 330 may include, for example, the actual website which would be navigated to by the browser while still displaying the list of the search elements 320, a screenshot of the webpage, a livestream of the webpage which is rendered on another device, or simply some text describing the webpage.

The visual results system may further include a server 103. The server 103 may include a computing device with the capability to visit and render any web page. In one example, the search system detects a search query 522 and presents the user with two lists of search suggestions 524. When a user highlights a particular search element 526, the computing device 101 may cause a server 103 to navigate to the web page associated with the highlighted search element and render that web page 526. The server 103 may then take a screenshot of the web page 528 and then send an image of the web page represented by that search element to the user device 101.

In one or more embodiments, when a user indicates a desire to see a web page represented by a search element, the computing device 101 sends a request to the server 103 for a screenshot of the corresponding web site or web page. This request may include a URL and other data relating to the request. The server 103, upon receiving a request for a screenshot from the computing device 101, may be configured to visit the specified URL, wait until the page has been rendered, and then take a screenshot of the web page once it has loaded. The server 103 may then transmit the screenshot of the web page to the user device 101 as a PNG, JPEG or other digital image format. The user device 101 would then display the image on the user interface provider 202. If the user then highlights a second search element 526, the visual results system would repeat and display an image for the second search element web page. In one embodiment, the visual results system may be configured to take a screenshot which is the correct size, corresponding to the user's device size or browser size. For example, if the client device is an iPhone® 6s, the system may specifically render and screenshot the website in 750*1334 pixels

In one or more embodiments, the server 103 may run the browser on top of optimized hardware to ensure the screenshot is taken as fast as possible but also under security isolation conditions, spawning a new browser per every new request, meaning no browsers are shared between requests. In an alternative embodiment, the server 103 may run the same browser from session to session for each unique user, allowing for a more customized search experience. Additionally, the server 103 computing device may include an ad-blocker, which would be of further benefit to end users.

The visual results system is beneficial to users, allowing them to enter a search query, and then simply hit the right arrow key, highlighting search elements representing results in order to get a preview of the web pages, until the user finds a web page which is satisfactory. Once the user finds a web page which is satisfying, the user may then hit the enter key to visit that site in the same tab, or hit an alternative key, for example the tab key, to open that result in a new tab.

In one or more embodiments, the suggestion engine may include data in the request being sent to the virtual computing device indicating that a specific portion of the web page to screenshot. This data may point to the portion of the screen most relevant to that particular search query. This data may include a snippet of text, a DOM element, or other pointer which represents a portion of the web page most relevant to the query. The server 103 computing device, upon receiving the request which includes a pointer to the most relevant portion of the web page, may then visit the specified URL, scroll to the specified portion, and then take a screenshot, which it would then send back to the client side device. One method which the virtual browser may use to visit a specific portion of a web page may include searching the DOM of a particular URL for a specified snippet of text.

In a further embodiment, the visual results system may overlay the image in a way that highlights the most relevant portion of text. For example, if a user searches for “best way to bake pizza”, and the web page which is rendered includes the text “the very best way to bake pizza is . . . ”, the visual results system may include a visual element to the image which indicates that this sentence may be of particular utility to the end user. In one example, the image displayed may include that bit of text underlined, or with an arrow pointed to that text, or with that bit of text in a bold typeface.

In one or more embodiments, the visual results system may calculate how long it will take to render the web page in the cloud, and may display, on the user interface provider, a loading animation, representing the amount of time left until the page will be displayed as an image.

In one or more embodiments, the visual results system may live stream the webpage associated with the highlighted search element instead of taking a screenshot which has been rendered on a server computing device.

In one or more embodiments, the visual results system may store images for results in a database on one or more servers so that the server 103 wouldn't need to render the entire web page each time a user indicates interest in a particular site. For example, if many people perform a particular search query, a server 103 may be configured to save and store the images which are rendered, and when a user performs a query, the search suggestion processor 102 may request an image from the server instead of rendering the web page. The server 103 may further be configured to periodically render a webpage to see if that web page has changed since the image has been stored.

In one or more embodiments, the visual results system may request that the server 103 render the web pages for one or more of the search elements 325 even before the user highlights them, so that loading time is further reduced. For example, suggestion processor 204 upon receiving a search query, may request screenshots for a multitude of search elements, and then save these images on the client side device in anticipation of the user highlighting those search elements. In one embodiment, the suggestion processor 204 may only request these additional screenshots once a first search element has been highlighted to save on the costs associated with rendering screenshots in the cloud.

In one or more embodiments, one or more search elements may represent advertisements. As the user highlights search elements, content associated with those search elements are displayed on a portion of the user interface. For example, as the user hits the right arrow key on a keyboard to navigate through the results, highlighting the first, and then the second result, a third result may be an ad. In order for the user to easily navigate to the fourth result, it would be necessary for the user to first highlight the third search element, making it more likely for users to see content which is paid for by advertisers. For example, if a user searches for “auto insurance,” the visual results system may display a number of search results which are not sponsored as search elements and also include one or more search elements which are sponsored by an advertiser. When a user highlights a search element which is representative of an ad, the user display may show a visual ad associated with that search element. This is beneficial to advertisers since users will almost always see these ads if they are viewing the list of results being that in order for the user to view the third search element in the list, for example, the user must first highlight the first two search elements in the list. Additionally, this is beneficial to advertisers since the ads would be visual, and could cover the full screen whereas, at the moment all search ads are simple snippets of text.

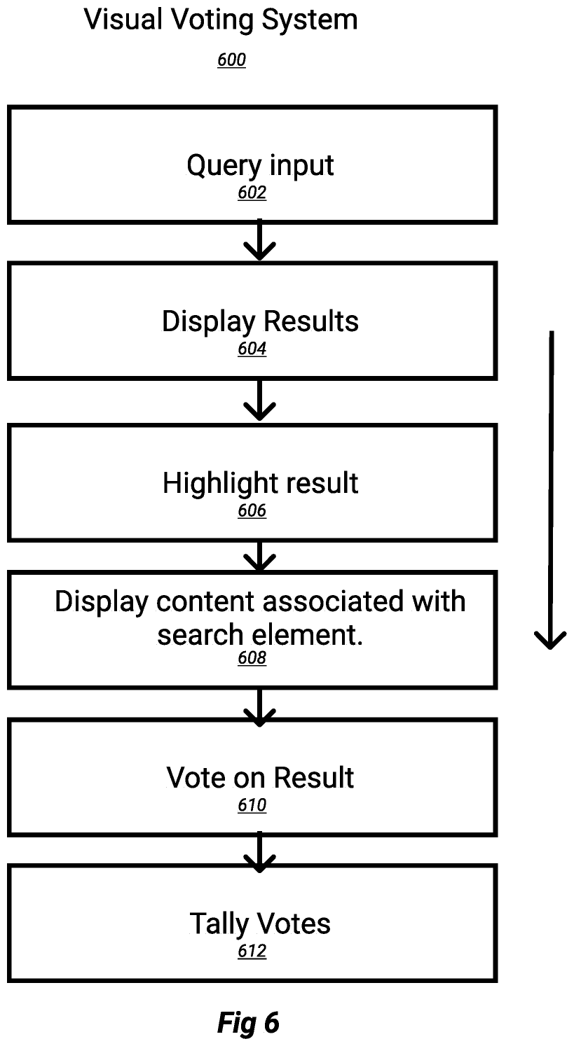

Discussed in more detail below, FIG. 6 illustrates a flowchart of a visual voting system for search engines. The system may detect a query input and display search elements representing results. The user may then highlight a search element, and the system may then display content associated with the highlighted search element on a graphical user interface. The system may then detect feedback on the highlighted search element via the user input detector 206. The system may then keep track of, record, and tally the total number of upvotes or downvotes 608 that a search element (or highlighted search element) has received, which may be beneficial to the user or to other users on the platform. The search system 200 may detect a user interaction on the input device 302 signifying that the user liked or did not like a particular search element representing a search result, allowing users to upvote or downvote the page which is being displayed. This is quite unique in that it allows users to view a particular web page while at the same time viewing all of the search results, and to give feedback at the same time. The search system 200 may then learn from people's upvotes/downvotes and rank web results accordingly based, at least in part, on the number of upvotes or downvotes 532. For example, the search suggestion processor 204 may automatically skip search results which are associated with a domain which a user has previously downvoted. Or, the search suggestion processor may alter the remaining search elements representing search results, the moment that a user upvotes or downvotes a particular result. For example, if a user searches “foot”, and then upvotes a result about the International Yard and Pound Agreement of 1959, the search suggestion engine may remove the rest of the results which are related to people's feet. This system is further illustrated in FIG. 6, where the user enters a query 602, and the system displays search elements representing results 604. The user highlights a search element, and the system displays content associated with that result. Critically, the graphical user interface displays the search elements on a portion of the page and content associated with the search element on a portion of the page. The user can then upvote or downvote that search element, and the system will count the total number of upvotes and downvotes in order to improve the ranking of search results in the future. For example, a greater number of upvotes may correlate to a higher ranking of the highlighted search term within the general list of search results.

As generally described thus far, FIGS. 3A-3D shows one embodiment of an example user interface 303. One will appreciate that other types of user interfaces may be used to implement one or more embodiments of the present invention. For example, FIG. 3A illustrates a viewing area that is conducive to an electronic search system. Other viewing areas may be used that are conducive to other forms of electronic search, such a VR or AR environment. Additionally, one will appreciate that multiple other combinations of two suggestion lists are possible. For example, a device may have a horizontal list of native apps, with a vertical list of search elements related to the app which is highlighted.

FIGS. 1-4C, the corresponding text, and the examples, provide a number of different systems and devices for using a communication element for electronic communication. In addition to the foregoing, embodiments of the present invention also can be described in terms of flowcharts comprising acts and steps in a method for accomplishing a particular result. For example, FIGS. 5 and 6 illustrate flowcharts of exemplary methods in accordance with one or more embodiments of the present invention. The methods described in relation to FIGS. 5 and 6 may be performed with less or more steps/acts or the steps/acts may be performed in differing orders. Additionally, the steps/acts described herein may be repeated or performed in parallel with one another or in parallel with different instances of the same or similar steps/acts.

FIGS. 5A and 5B illustrate flowcharts of two examples of methods 500 and 550 of searching and selecting a search element 322 within an electronic search system. The method 500 includes an act 502 of detecting a user interaction. In particular, act 502 can involve detecting a user interaction with a graphical user interface 303. For example, act 502 can include the user interface provider 202 providing the user interface 303. In addition, act 502 can include the user input detector 206 detecting a user interaction with a user input device, for example the touch screen 302. The user interaction may include a user highlighting a search element (i.e., 322, 311, 324, 314, 314, 326) from one of the suggestion lists 310, 320.

In addition, method 500 further includes an act 504 of presenting search elements 310, 320. In particular, act 504 can include presenting two lists of search suggestions 310, 320, which include one or more search elements 321, 322, 323, 311, 312, 314, 325, in response to the detected user query. To accomplish this, a search suggestion processor 204 may send suggested search elements in response to receiving the search query from the user input detector 206. For example, the search suggestion lists with search elements may be presented in the viewing area 304 of the user interface 303.

Method 500 can additionally include an act 506 of determining an interaction with one of these suggestion lists 310, or 320. In particular, the act 506 can include determining which search element on the suggestion list, which has been interacted with, has been highlighted.

Furthermore, method 500 can also include an act 508 of updating the second list of search suggestions 320, or 310, which was not yet interacted with, by displaying search elements based on the highlighted search element on the first list. For example, the search element controller 208 can lookup search elements to display on the second search suggestions list 320, or 310 which are related to the search element that was highlighted on the first list. The search element controller 208 can then cause the user interface provider 202 to present these search elements on the second list 320, or 310 which was not interacted with.

Method 500 can additionally include an act 508 of determining an interaction with the second suggestion list 320, or 310. In particular, the act 508 can include determining which search element on the second has been highlighted.

Referring now to FIG. 5B, method 550 can alternatively include an act 526 of determining which search element 326 has been highlighted, and then, based on that interaction, present a user with a view of the web page 303 associated with said search element 326 on the viewing area 304 of the user interface 303 while the full list of search suggestions 320 is still being presented in the viewing area 304 of the user interface 303.

Method 550 can alternatively include an act 526 of determining which search element 326 has been highlighted, and then, based on that interaction, render that webpage on a server 103, and then send that image to a user computing device 101 and present a user with an image of the web page 303 associated with said search element 326 on the viewing area 304 of the user interface 303 while the full list of search suggestions 320 is still being presented in the viewing area 304 of the user interface 303.

Referring now to FIG. 6, a method of providing a visual voting system 600 is shown. According to one or more embodiments, the method includes receiving a query input from as user of a computing device 101 (Block 602). The computing device then generates and displays a list of search results associated with the with the search query (Block 604). The list of search results includes one or more search elements 326. Once the list of search results has been generated, the user may highlight a desired search element 326 (Block 606) and display content associated with highlighted search element on a portion of the GUI 303 (Block 608). The user may then upvote or downvote the search element 326 by highlighting the search element (Block 610). Once the user has voted, the computing device 101 tallies the number of votes that the search 326 has received by the user of computing device 101 and other users (Block 612). The system 600 may then use the tally of upvotes/downvotes to modify the ranking of the search results to the user who has voted on the search element, and to other users.

FIG. 7 illustrates, in block diagram form, an exemplary computing device 700 that may be configured to perform one or more of the processes described above. One will appreciate that system 100, computing devices 102, server 103, and/or system 200 each comprise one or more computing devices in accordance with implementations of computing device 700. As shown by FIG. 7, the computing device can comprise a processor 702, a memory 704, a storage device 706, an I/O interface 708, and a communication interface 710, which may be communicatively coupled by way of communication infrastructure 712. While an exemplary computing device 700 is shown in FIG. 7, the components illustrated in FIG. 7 are not intended to be limiting. Additional or alternative components may be used in other embodiments. Furthermore, in certain embodiments, a computing device 700 can include fewer components than those shown in FIG. 7. Components of computing device 700 shown in FIG. 7 will now be described in additional detail.

In particular embodiments, processor 702 includes hardware for executing instructions, such as those making up a computer program. As an example, and not by way of limitation, to execute instructions, processor 702 may retrieve (or fetch) the instructions from an internal register, an internal cache, memory 704, or storage device 706 and decode and execute them. In particular embodiments, processor 702 may include one or more internal caches for data, instructions, or addresses. As an example, and not by way of limitation, processor 702 may include one or more instruction caches, one or more data caches, and one or more translation lookaside buffers (TLBs). Instructions in the instruction caches may be copies of instructions in memory 704 or storage 706.

Memory 704 may be used for storing data, metadata, and programs for execution by the processor(s). Memory 704 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. Memory 704 may be internal or distributed memory.

Storage device 706 includes storage for storing data or instructions. As an example, and not by way of limitation, storage device 706 can comprise a non-transitory storage medium described above. Storage device 706 may include a hard disk drive (HDD), a floppy disk drive, flash memory, an optical disc, a magneto-optical disc, magnetic tape, or a Universal Serial Bus (USB) drive or a combination of two or more of these. Storage device 706 may include removable or non-removable (or fixed) media, where appropriate. Storage device 706 may be internal or external to the computing device 700. In particular embodiments, storage device 706 is non-volatile, solid-state memory. In other embodiments, Storage device 706 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

I/O interface 708 allows a user to provide input to, receive output from, and otherwise transfer data to and receive data from computing device 700. I/O interface 708 may include a mouse, a keypad or a keyboard, a touch screen, a camera, an optical scanner, network interface, modem, other known I/O devices or a combination of such I/O interfaces. I/O interface 708 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interface 708 is configured to provide graphical data to a display for presentation to a user. The graphical data may be representative of one or more graphical user interfaces and/or any other graphical content as may serve a particular implementation.

Communication interface 710 can include hardware, software, or both. In any event, communication interface 710 can provide one or more interfaces for communication (such as, for example, packet-based communication) between computing device 700 and one or more other computing devices or networks. As an example, and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI.

Additionally or alternatively, communication interface 710 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, communication interface 710 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Communication infrastructure 712 may include hardware, software, or both that couples components of computing device 700 to each other. As an example and not by way of limitation, communication infrastructure 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

As mentioned above, system 200 may be linked to and/or implemented within a search system. An electronic search system may enable its users to interact with the system to find information online. The search system may provide users with an interactive search experience.

FIG. 8 illustrates an example search environment of a search system. In particular embodiments, a search system 802 may comprise one or more data stores. In particular embodiments, the search system 802 may store information related to a search system, including, but not limited to, a number of search elements and/or suggestions for any given query. These elements may include a list of web pages that were publicly saved, or “pinned”; by users for a given domain, a number of web pages that were suggested by the domain owner; a number of pages which a user has saved privately; a predictive model for each user which predicts which site the user is most likely to visit next; ads which may include keywords, bidding information, and upvoting information; or query recommendations.

In particular embodiments, the search system 802 may comprise one or more computing devices (e.g., servers) hosting functionality directed to operation of the search system 802. A user of the search system 802 may access the search system 802 using a client device such as client device 806. In particular embodiments, the client device 806 can interact with the search system 802 through a network 804.

The client device 806 may be a desktop computer, a laptop computer, a tablet computer, a personal digital assistant (PDA), an in- or out-of-car navigation system, a smart phone or other cellular or mobile phone, or a mobile gaming device, other mobile device, or other suitable computing devices. Client device 806 may execute one or more client applications, such as a web browser (e.g., Microsoft Windows Internet Explorer®, Mozilla Firefox®, Apple Safari®, Google Chrome®, Opera®, etc.) or a native or special-purpose client application (e.g., Facebook® for iPhone® or iPad®, Facebook® for Android®, etc.), to access and view content over network 804.

Network 804 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which client devices 806 may access the search system 802.

While these methods, systems, and user interfaces utilize both publicly available information as well as information provided by users of the search system, all use of such information is to be explicitly subject to all privacy settings of the involved users and the privacy policy of the search system as a whole.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure. Various different exemplary embodiments can be used together with one another, as well as interchangeably therewith, as should be understood by those having ordinary skill in the art. In addition, certain terms used in the present disclosure, including the specification and drawings, can be used synonymously in certain instances, including, but not limited to, for example, data and information. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

1. A computer implemented method, comprising:
providing an input device having:
at least one processor; and
a graphical user interface (GUI) displaying a search input area; and
receiving a search query from a user of the input device;
determining, with the at least one processor, at least one search element to display on the GUI;
requesting, from a server, two or more lists of search suggestions;
displaying, on the GUI, the two or more lists of search suggestions to the user as the user enters the search query; and
detecting, with the at least one processor, a user interaction with one of the two or more lists of search suggestions.

2. The method of claim 1, wherein the search query includes characters entered by the user into the search input area, the characters being displayed on the GUI.

3. The method of claim 1, wherein:
the input device includes a keyboard; and
when the user presses a designated key on the keyboard to complete the search query, the user is directed to a search results page associated with the search query received from the user.

4. The method of claim 1, wherein the two or more lists of search suggestions each include one or more search elements related to the search query and are displayed simultaneously as the search query is received from the user.

5. The method of claim 4, wherein the user interaction with one of the two or more lists of search suggestions is detected by highlighting one search element on a first list of the two or more lists of search suggestions.

6. The method of claim 5, wherein upon detecting the highlighting of a search element on the first list, a second list of the two or more lists of search suggestions is at least one of updated, modified, or removed by the input device.

7. The method of claim 1, wherein the at least one processor includes a search suggestion processor configured to:
receive the search query from the user; and
detect highlighting of a search element.

8. The method of claim 1, wherein the two or more lists of search suggestions includes:
a first list of search suggestions displayed in a horizontal row above a search bar of the input device; and
a second list of search suggestions displayed in a vertical row under the search bar.

9. The method of claim 8, wherein search elements on the horizontal list of suggestions are each represented by an icon or correspond to an associated domain.

10. The method of claim 1, wherein the two or more lists of search suggestions includes:
a first list of search suggestions which includes one or more search elements representing domains; and
a second list of search suggestions which includes one or more search elements representing web pages within a domain highlighted on the first list of search suggestions.

11. The method of claim 1, wherein the two or more lists of search suggestions includes:
a first list of search suggestions which includes search elements representing web pages within a domain;
a second list of search suggestions which includes search elements representing at least one domain associated with the search query; and
wherein the first list of search suggestions is displayed in a horizontal row above a search bar of the input device and the second list of search suggestions is displayed in a vertical row under the search bar.

12. The method of claim 11, wherein an interaction with a search element of at least one of the first and second lists is detected by a user input detector.

13. The method of claim 11, wherein:
when a search element representing a domain is selected, the user is directed to the domain associated with the selected search element; and
when a search element representing a web page within a domain is selected, the user is directed to the web page.

14. A computer-implemented method, comprising:
providing an input device having a graphical user interface (GUI) and a search bar, the input device being configured to allow a user to type a search query into the search bar;
receiving the search query from the user;
providing and displaying a search suggestion list to the user on a first portion of the GUI as the user types the search query, the search query including one or more search elements each associated with a website;
highlighting, with the user input device, a search element from the one or more search elements;
displaying content from a webpage of the website on a second portion of the GUI;
engaging, with the user input device, the highlighted search element; and
directing the user to a uniform resource locator (URL) associated with the highlighted search result.

15. The method of claim 14, wherein the displayed content from the website includes at least one of:
a screenshot of a portion of the webpage that corresponds to the search query;
a screenshot of the webpage that includes a visual overlay over a portion of the webpage that corresponds to the search query;
a live feed of the webpage; and
a textual description of the webpage.

16. A computer-implemented method for ranking web-based search results, the method comprising:
providing an input device having a graphical user interface (GUI) and a search bar, the input device being configured to allow a user to type a search query into the search bar;
receiving the search query from the user;
generating a list of search elements based on the received search query, each search element being associated with a website;
detecting whether the user has highlighted a search element from the generated list, the user highlighting the search element with the input device;
displaying the generated list of search elements on a portion of the GUI;
displaying content associated with the website of the highlighted search result on a portion of the GUI;
detecting at least one user input indicative of an upvote of the highlighted search element, and;
recording how many upvotes and downvotes the highlighted search element receives.

17. The method of claim 16, wherein the highlighted search element is ranked in the generated list based how many upvotes and downvotes the highlighted search element receives.

18. The method of claim 17, wherein the a greater number of upvotes correlates to a higher ranking of the highlighted search term within the generated list.

19. The method of claim 16, wherein the input device has a keyboard configured to allow the user to highlight the search element.

20. The method of claim 19, wherein the input device has a processor configured to detect user input from the keyboard.
